(19) United States
(12) Patent Application Publication
(10) Pub. No.: US 2006/0013320 A1
(43) Pub. Date: Jan. 19, 2006

(54) Methods and apparatus for spatial error concealment

(76) Inventors: Seyfullah Halit Oguz, San Diego, CA (US); Vijayalakshmi R. Raveendran, San Diego, CA (US)

Correspondence Address: QUALCOMM, INC, 5775 MOREHOUSE DR., SAN DIEGO, CA, 92121, US

(21) Appl. No.: 11/182,621

(22) Filed: Jul. 15, 2005

Related U.S. Application Data
(60) Provisional application No. 60/588,483, filed on Jul. 15, 2004.

(51) Int. Cl. H04B 1/66; H04N 11/04; H04N 7/12; H04N 11/02

(52) U.S. Cl. 375/240.27; 375/240.24

(57) ABSTRACT

Methods and apparatus for spatial error concealment. A method is provided for spatial error concealment. The method includes detecting a damaged macroblock, and obtaining coded macroblock parameters associated with one or more neighbor macroblocks. The method also includes generating concealment parameters based on the coded macroblock parameters, and inserting the concealment parameters into a video decoding system.

### CLAIM OF PRIORITY UNDER 35 U.S.C. §119

The present Application for Patent claims priority to Provisional Application No. 60/588,483 entitled “Method and Apparatus for Spatial Error Concealment for Block-Based Video Compression” filed Jul. 15, 2004, and assigned to the assignee hereof and hereby expressly incorporated by reference herein.

### BACKGROUND

1. Field

Embodiments relate generally to the operation of video distribution systems, and more particularly, to methods and apparatus for spatial error concealment for use with video distribution systems.

2. Background

Data networks, such as wireless communication networks, are being increasingly used to delivery high quality video content to portable devices. For example, portable device users are now able to receive news, sports, entertainment, and other information in the form of high quality video clips that can be rendered on their portable devices. However, the distribution of high quality content (video) to a large number of mobile devices (subscribers) remains a complicated problem because mobile devices typically communicate using relatively slow over-the-air communication links that are prone to signal fading, drop-outs and other degrading transmission effects. Therefore, it is very important for content providers to have a way to overcome channel distortions and thereby allow high quality content to be received and rendered on a mobile device.

Typically, high quality video content comprises a sequence of video frames that are rendered at a particular frame rate. In one technique, each frame comprises data that represents red, green, and blue information that allows color video to be rendered. In order to transmit the video information from a transmitting device to a receiving playback device, various encoding technologies have been employed. Typically, the encoding technology provides video compression to remove redundant data and provide error correction for video data transmitted over wireless channels. However, loss of any part of the compressed video data during transmission impacts the quality of the reconstructed video at the decoder.

One compression technology based on developing industry standards is commonly referred to as “H.264” video compression. The H.264 technology defines the syntax of an encoded video bitstream together with the method of decoding this bitstream. In one embodiment of an H.264 encoding process, an input video frame is presented for encoding. The frame is processed in units of macroblocks corresponding to 16×1 6 pixels in the original image. Each macroblock can be encoded in intra or inter mode. A prediction macroblock I is formed based on a reconstructed frame. In intra mode, I is formed from samples in the current frame n that have been previously encoded, decoded, and reconstructed. The prediction I is subtracted from the current macro block to produce a residual or different macroblock D. This is transformed using a block transform and quantized to produce X, a set of quantized transformed coefficients. These coefficients are re-ordered and entropy encoded. The entropy encoded coefficients, together with other information required to decode the macroblock, become part of a compressed bitstream that is transmitted to a receiving device.

Unfortunately, during the transmission process, errors in one or more macroblocks may be introduced. For example, one or more degrading transmission effects, such as signal fading, may cause the loss of data in one or more macroblocks. As a result, error concealment has become critical when delivering multimedia content over error prone networks such as wireless channels. Error concealment schemes make use of the spatial and temporal correlation that exists in the video signal. When errors are encountered, recovery needs to occur during entropy decoding. For example, when packet errors are encountered, all or parts of the data pertaining to one or more macroblocks or video slices could be lost. When all but coding mode is lost, recovery is through spatial concealment for intra coding mode and through temporal concealment for inter coding mode.

Several spatial concealment techniques have been used in conventional systems in an attempt to recover from errors that have corrupted one or more macroblocks in a video transmission. In one technique, a weighted average of neighbor pixels is used to determine values for the lost pixels. Unfortunately, this simple technique may result in smearing edge structures that may be part of the original video frame. Thus, the resulting concealment data may not provide satisfactory error concealment when the lost macroblock is ultimately rendered on a playback device.

Another technique used in conventional systems to provide spatial error concealment relies on computationally intensive filtering and thresholding operations. In this technique, a boundary of neighbor pixels is defined around a lost macroblock. The neighbor pixels are first filtered and the result undergoes a threshold detection process. Edge structures detected in the neighbor pixels are extended into the lost macroblock and are used as a basis for generating concealment data. Although this technique provides better results than the weighted averages technique, the filtering and thresholding operations are computationally intensive, and as a result, require significant resources at the decoder.

Therefore, it would be desirable to have a system that operates to provide spatial error concealment for use with video transmission systems. The system should operate to avoid the problems of smearing inherent with simple weighted averaging techniques, while requiring less computational expense than that required by filtering and thresholding techniques.

### SUMMARY

In one or more embodiments, a spatial error concealment system is provided for use in video transmission systems. For example, the system is suitable for use with wireless video transmission systems utilizing H.264 encoding and decoding technology.

In one embodiment, a method is provided for spatial error concealment. The method comprises detecting a damaged macroblock, and obtaining coded macroblock parameters associated with one or more neighbor macroblocks. The method also comprises generating concealment parameters based on the coded macroblock parameters, and inserting the concealment parameters into a video decoding system.

In one embodiment, an apparatus is provided for spatial error concealment. The apparatus comprises logic configured to detect a damaged macroblock, and logic configured to obtain coded macroblock parameters associated with one or more neighbor macroblocks. The apparatus also comprises logic configured to generate concealment parameters based on the coded macroblock parameters, and logic configured to insert the concealment parameters into a video decoding system.

In one embodiment, an apparatus is provided for spatial error concealment. The apparatus comprises means for detecting a damaged macroblock, and means for obtaining coded macroblock parameters associated with one or more neighbor macroblocks. The apparatus also comprises means for generating concealment parameters based on the coded macroblock parameters, and means for inserting the concealment parameters into a video decoding system.

In one embodiment, a computer-readable media is provided that comprises instructions, which when executed by at least one processor, operate to provide spatial error concealment. The computer-readable media comprises instructions for detecting a damaged macroblock, and instructions for obtaining coded macroblock parameters associated with one or more neighbor macroblocks. The computer-readable media also comprises instructions for generating concealment parameters based on the coded macroblock parameters, and instructions for inserting the concealment parameters into a video decoding system.

In one embodiment, at least one processor is provided and configured to perform a method for spatial error concealment. The method comprises detecting a damaged macroblock, and obtaining coded macroblock parameters associated with one or more neighbor macroblocks. The method also comprises generating concealment parameters based on the coded macroblock parameters, and inserting the concealment parameters into a video decoding system.

Other aspects of the embodiments will become apparent after review of the hereinafter set forth Brief Description of the Drawings, Detailed Description, and the claims.

### BRIEF DESCRIPTION OF THE DRAWINGS

The foregoing aspects of the embodiments described herein will become more readily apparent by reference to the following detailed description when taken in conjunction with the accompanying drawings wherein:

FIG. 1 shows a video frame to be encoded for transmission to a receiving playback device;

FIG. 2 shows a detailed diagram of a macroblock included in the video frame of FIG. 1;

FIG. 3 shows a detailed diagram of a block and its surrounding neighbor pixels;

FIG. 4 shows a directivity mode diagram that illustrates nine directivity modes (0-9) which are used to describe a directivity characteristic of a block;

FIG. 5 shows a diagram of an H.264 encoding process that is used to encode a video frame;

FIG. 6 shows one embodiment of a network that comprises one embodiment of a spatial error concealment system;

FIG. 7 shows a detailed diagram of one embodiment of a spatial error concealment system;

FIG. 8 shows one embodiment of spatial error concealment logic suitable for use in one or more embodiments of a spatial error concealment system;

FIG. 9 shows a method for providing spatial error concealment at a device;

FIG. 10 shows one embodiment of a macroblock parameters buffer for use in one embodiment of a spatial error concealment system;

FIG. 11 shows one embodiment of a loss map for use in one embodiment of a spatial error concealment system;

FIG. 12 shows one embodiment of a macroblock to be concealed and its four causal neighbors;

FIG. 13 shows a macroblock that illustrates an order in which the concealment process scans all 16 intra_{—}4×4 blocks to determine intra_{—}4×4 prediction (directivity) modes;

FIG. 14 shows a macroblock to be concealed and ten blocks from neighbor macroblocks to be used in the concealment process;

FIG. 15 shows one embodiment of four clique types (1-4) that describe the relationship between 4×4 neighbor blocks and a 4×4 block to be concealed;

FIG. 16 shows a mode diagram that illustrates the process of quantizing a resultant directional vector in one embodiment of a spatial error concealment system;

FIG. 17 illustrates one embodiment of propagation Rule #1 for diagonal classification consistency in one embodiment of a spatial error concealment system;

FIG. 18 illustrates one embodiment of propagation Rule #2 for generational differences in one embodiment of a spatial error concealment system;

FIG. 19 illustrates one embodiment of propagation Rule #3 for obtuse angle defining neighbors in one embodiment of a spatial error concealment system;

FIG. 20 illustrates one embodiment of stop Rule #1 pertaining to Manhattan corners in one embodiment of a spatial error concealment system;

FIG. 21 illustrates the operation of one embodiment of a spatial concealment algorithm for concealing lost chrominance (Cb and Cr) channel 8×8 pixel blocks;

FIG. 22 shows a diagram of luma and chroma (Cr, Cb) macroblocks to be concealed in one embodiment of an enhanced spatial error concealment system;

FIG. 23 shows one embodiment of an enhanced loss map;

FIG. 24 shows one embodiment of the enhanced loss map shown in FIG. 23 that includes mark-ups to show the receipt of non-causal information;

FIG. 25 provides one embodiment of a method for providing enhanced SEC;

FIG. 26 provides one embodiment of a method for determining when it is possible to utilize enhanced SEC features;

FIG. 27 shows one embodiment of a method that provides an algorithm for achieving mean brightness (i.e. luma channel), correction in the lower half of a concealment macroblock in one embodiment of an enhanced SEC;

FIG. 28 illustrates definitions for variables used in the method shown in FIG. 27;

FIG. 29 shows a block and identifies seven (7) pixels used for performing intra_{—}4×4 predictions on neighboring 4×4 blocks;

FIG. 30 shows one embodiment of an intra_{—}4×4 block immediately below a slice boundary;

FIG. 31 illustrates the naming of neighbor pixels and pixels within an intra_{—}4×4 block;

FIG. 32 shows one embodiment of an intra_{—}16×16 coded macroblock located below a slice boundary; and

FIG. 33 shows one embodiment of a chroma channel immediately below a slice boundary.

### DETAILED DESCRIPTION

In one or more embodiments, a spatial error concealment system is provided that operates to conceal errors in a received video transmission. For example, the video transmission comprises a sequence of video frames where each frame comprises a plurality of macroblocks. A group of macroblocks can also define a video slice, and a frame can be divided into multiple video slices. An encoding system at a transmitting device encodes the macroblocks using H.264 encoding technology. The encoded macroblocks are then transmitted over a transmission channel to a receiving device, and in the process, one or more macroblocks are lost, corrupted, or otherwise unusable so that observable distortions can be detected in the reconstructed video frame. In one embodiment, the spatial error concealment system operates to detect damaged macroblocks and generate concealment data based on directional structures associated with undamaged, repaired, or concealed neighbor macroblocks. As a result, damaged macroblocks can be efficiently concealed to provide an esthetically pleasing rendering of the video frame. The system is especially well suited for use in wireless networks environments, but may be used in any type of wireless and/or wired network environment, including but not limited to, communication networks, public networks, such as the Internet, private networks, such as virtual private networks (VPN), local area networks, wide area networks, long haul network, or any other type of data network. The system is also suitable for use with virtually any type of video playback device.

Video Frame Encoding

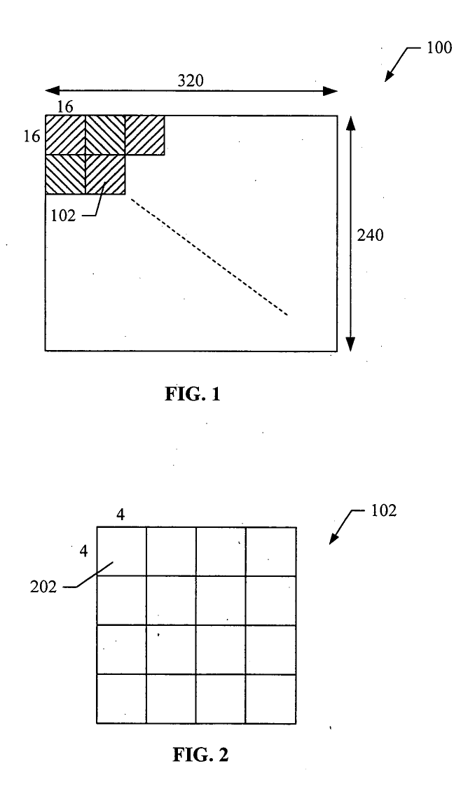

FIG. 1 shows a video frame 100 to be encoded for transmission to a receiving playback device. For example, the video frame 100 may be encoded using H.264 video encoding technology. The video frame 100 in this embodiment, comprises 320×240 pixels of video data, however, the video frame may comprise any desired number of pixels. Typically, for color video, the video frame 100 comprises luminance and chrominance (Y, Cr, Cb) data for each pixel. For clarity, embodiments of the spatial error concealment system will first be described with reference to the concealment of lost luminance data. However, additional embodiments are also provided that are more specifically applicable to the concealment of lost chrominance data as well.

The video frame 100 is made up of a plurality of macroblocks, where each macroblock comprises a data array of 16×16 pixels. For example, macroblock 102 comprises 16×16 pixels of video data. As described in the following sections, the macroblocks of the video frame 100 are encoded under H.264 and various coding parameters associated with the encoded macroblocks are placed into a video stream for transmission to the playback device. In one embodiment, H.264 provides for encoding the 16×16 macroblocks in what is referred to as intra_{—}16×16 encoding. In another embodiment, H.264 provides for encoding the 16×16 macroblocks in blocks of 4×4 pixels in what is referred to as intra_{—}4×4 encoding. Thus, the video data may be encoded using various block sizes; however, one or more embodiments of the concealment system are suitable for use regardless of the block size used.

FIG. 2 shows a detailed diagram of the macroblock 102. The macroblock 102 is made up of a group of 16 blocks, where each block comprises a data array of 4×4 pixels. For example, the block 202 comprises a data array of 4×4 pixels.

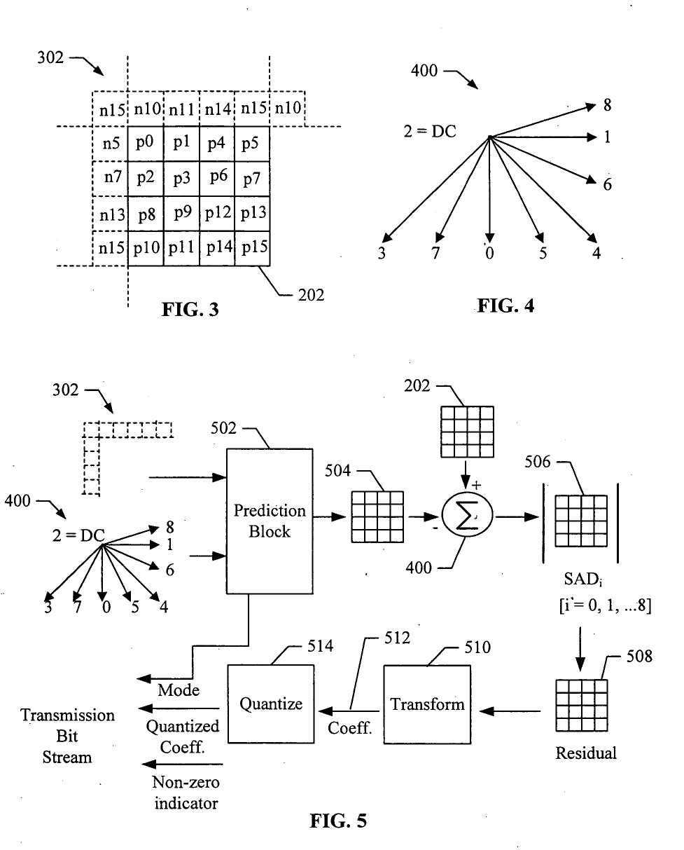

FIG. 3 shows a detailed diagram of the block 202 and its surrounding neighbor pixels, shown generally at 302. For example, during the H.264 encoding process, the neighbor pixels 302 are used to generate various parameters describing the block 202. The block 202 comprises pixels (p0-p15) and the neighbor pixels 302 are identified using reference indicators corresponding to the positions of the block 202 pixels.

FIG. 4 shows a directivity mode diagram 400 that illustrates nine directivity modes (0-9) (or indicators) that are used to describe a directivity characteristic of the block 202. For example, mode 0 describes a vertical directivity characteristic, mode 1 describes a horizontal directivity characteristic, and mode 2 describes a DC characteristic. The modes illustrated in the directivity mode diagram 400 are used in the H.264 encoding process to generated prediction parameters for the block 202.

FIG. 5 shows a diagram of an H.264 encoding process that is used to encode a video frame. It will be assumed that the H.264 encoding process performs intra_{—}4×4 encoding to encode each block of the video frame; for example, the block 202 can be encoded using the encoding process shown in FIG. 5. In one embodiment, if a macroblock is coded as intra_{—}16×16, with directivity modes horizontal, vertical or DC, the 16 4×4 blocks comprising the macroblock are assigned the appropriate intra_{—}4×4 mode corresponding to the intra_{—}16×16 mode. For example, if the intra_{—}16×16 mode is DC, its 16 4×4 blocks are assigned DC. If the intra 16×16 mode is horizontal, its 16 4×4 blocks are assigned directivity mode 1. If the intra_{—}16×16 mode is vertical, its 16 4×4 blocks are assigned directivity mode 0 as shown in FIG. 4.

It should also be noted that in H.264, intra prediction is not permitted across slice boundaries. This could prohibit some of the directional modes and result in the mode being declared as DC. This impacts the accuracy of the mode information in neighbor macroblocks. Additionally, when a 4×4 block is assigned a DC mode in this manner, the residual energy goes up which is reflected as an increase in number of non-zero coefficients. Since the weights assigned to the mode information in the propagation rules for the proposed SEC algorithm depends on the residual energy, the inaccuracy due to restricted intra-prediction is handled appropriately.

During encoding, prediction logic 502 processes the neighbor pixels 302 according to the directivity modes 400 to generate a prediction block 504 for each directivity mode. For example, the prediction block 504 is generated by extending the neighbor pixels 302 into the prediction block 504 according to the selected directivity mode. Each prediction block 504 is subtracted from the original block 202 to produce nine “sum of absolute differences” (SADᵢ) blocks 506. A residual block 508 is determined from the nine SADᵢ blocks 506 based on which of the nine SADᵢ blocks 506 has the minimum SAD values (MINSAD), most zero values, or based on any other selection criteria. Once the residual block 508 is determined, it is transformed by the transform logic 510 to produce transform coefficients 512. For example, any suitable transform algorithm for video compression may be used, such as a discrete cosine transform (DCT). The transform coefficients 512 are quantized at block 514 to produce quantized transform coefficients which are written to the transmission bit stream along with the directivity mode value that produced the selected residual block 508. The transmission bit stream is then processed for transmission over a data network to a playback device. Other parameters may also be included in the transmission bit stream, such as an indicator that indicates the number of non-zero coefficients associated with the residual block 508.

During the transmission process, one or more of the macroblocks may be lost, corrupted or otherwise unusable as a result of degrading transmission effects, such as signal fading. Thus, in one or more embodiments, the spatial error concealment system operates at the playback device to generate concealment data for the damaged macroblocks to provide an esthetically pleasing rendering of the received video information.

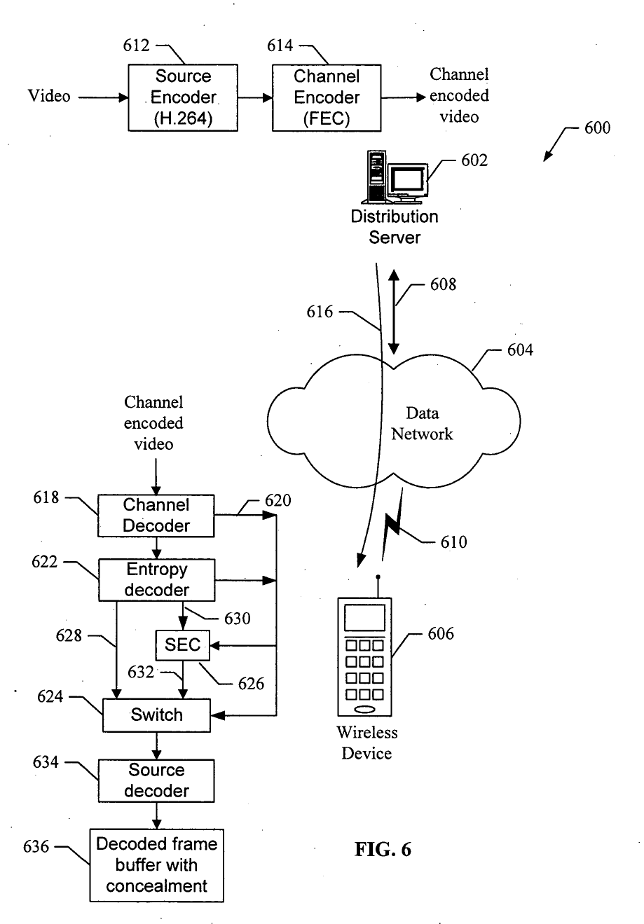

FIG. 6 shows one embodiment of a network 600 that comprises one embodiment of a spatial error concealment system. The network 600 comprises a distribution server 602, a data network 604, and a wireless device 606. The distribution server 602 communicates with the data network through communication link 608. The communication link 608 comprises any type of wired or wireless communication link.

The data network 604 comprises any type of wired and/or wireless communication network. The data network 604 communicates with the device 606 using the communication link 610. Communication link 610 comprises any suitable type of wireless communication link. Thus, the distribution server 602 communicates with the device 606 using the data network 604 and the communication links 608, 610.

In one embodiment, the distribution server 602 operates to transmit encoded video data to the device 606 using the data network 604. For example, the server 602 comprises a source encoder 612 and a channel encoder 614. In one embodiment, the source encoder 612 receives a video signal and encodes macroblocks of the video signal in accordance with H.264 encoding technology. However, embodiments are suitable for use with other types of encoding technologies. The channel encoder 614 operates to receive the encoded video signal and generate a channel encoded video signal that incorporates error correction, such as forward error correction. The resulting channel encoded video signal is transmitted from the distribution server 602 to the device 606 as shown by path 616.

The channel encoded video signal is received at the device 606 by a channel decoder 618. The channel decoder 618 decodes the channel encoded video signal and detects and corrects any errors that may have occurred during the transmission process. In one embodiment, the channel decoder 618 is able to detect errors but is unable to correct for them because of the severity of the errors. For example, one or more macroblocks may be lost or corrupted due to signal fading or other transmission effects that are so severe that the decoder 618 is unable to correct them. In one embodiment, when the channel decoder 618 detects macroblock errors, it outputs an error signal 620 that indicates that uncorrectable macroblocks errors have been received.

A channel decoded video signal is output from the channel decoder 618 and input to an entropy decoder 622. The entropy decoder 622 decodes macroblock parameters such as directivity mode indicators and coefficients from the channel decoded video signal. The decoded information is stored in a macroblock parameters buffer that may be part of the entropy decoder 622. In one embodiment, the decoded macroblock information is input to a switch 624 (through path 628) and information from the parameters buffer is accessible to spatial error concealment (SEC) logic 626 (through path 630). In one embodiment, the entropy decoder 622 may also operate to detect damaged macroblocks and output the error signal 620.

In one embodiment, the SEC logic 626 operates to generate concealment parameters comprising directivity mode information and coefficients for macroblocks that are lost due to transmission errors. For example, the SEC logic 626 receives the error indicator 620, and in response, retrieves macroblock directivity information and transform coefficients associated with healthy (error free) macroblock neighbors. The SEC logic 626 uses the neighbor information to generate concealment directivity mode information and coefficient parameters for lost macroblocks. A more detailed description of the SEC logic 626 is provided in another section of this document. The SEC logic 626 outputs the generated directivity mode information and coefficient parameters for lost macroblocks to the switch 624, as shown by path 632. Thus, the SEC logic 626 inserts the concealment parameters for lost macroblocks into the decoding system.

The switch 624 operates to select information from one of its two inputs to output at a switch output. The operation of the switch is controlled by the error signal 620. For example, in one embodiment, when there are no macroblock errors, the error signal 620 controls the switch 624 to output the directivity mode indicator and coefficient information received from the entropy decoder 622. When macroblock errors are detected, the error signal 620 controls the switch 624 to output the directivity mode indicator and coefficient parameters received from the SEC logic 626. Thus, the error signal 620 controls the operation of the switch 624 to convey either correctly received macroblock information from the entropy decoder 622, or concealment information for damaged macroblocks from the SEC logic 626. The output of the switch is input to source decoder 634.

The source decoder 634 operates to decode the transmitted video data using the directivity mode indicator and coefficient information received from the switch 624 to produce a decoded video frame that is stored in the frame buffer 636. The decoded frames include concealment data generated by the SEC logic 626 for those macroblocks that contained uncorrectable errors. Video frames stored in the frame buffer 636 may then be rendered on the device 606 such that the concealment data generated by the SEC logic 626 provides an esthetically pleasing rendering of lost or damaged macroblocks.

Therefore, in one or more embodiments, a spatial error concealment system is provided that operates to generate concealment data for lost or damaged macroblocks in a video frame. In one embodiment, the concealment information for damaged macroblocks is generated from directivity mode information and transform coefficients associated with error free or previously concealed neighbor macroblocks. As a result, the system is easily adaptable to existing video transmission systems using H.264 encoding technology because only modifications to the playback device may be needed to obtain improved spatial error concealment as provided by the embodiments.

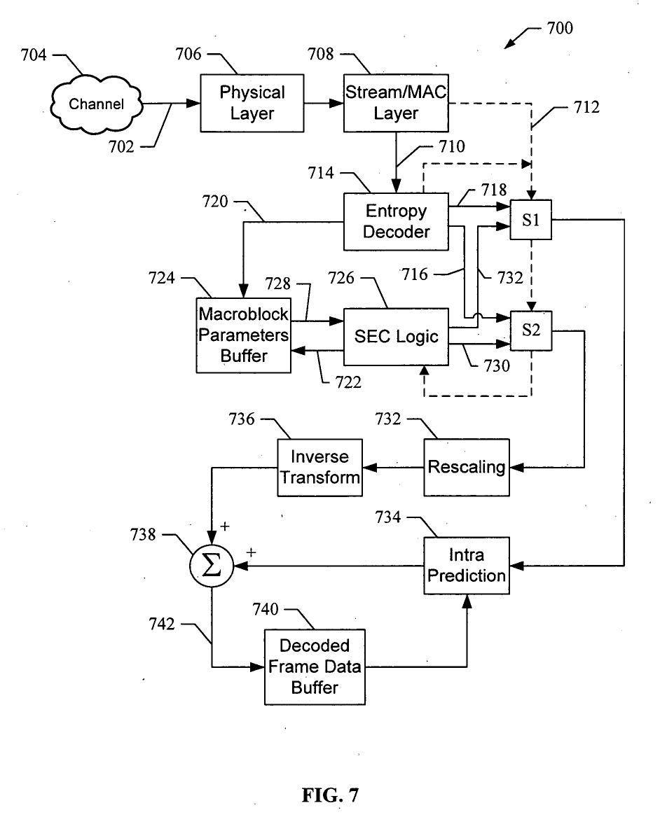

FIG. 7 shows a detailed diagram of one embodiment of a spatial error concealment system 700. For example, the system 700 is suitable for use with the device 106 shown in FIG. 1. It should be noted that the system 700 represents just one implementation and that other implementations are possible within the scope of the embodiments.

For the purpose of this description, it will be assumed that the spatial error concealment system 700 receives a video transmission 702 through a wireless channel 704. In one embodiment, the video transmission 702 comprises video information encoded using H.264 technology as described above, and therefore comprises a sequence of video frames where each frame contains a plurality of encoded macroblocks. It will further be assumed that as a result of degradation of the channel 704, one or more macroblocks include errors that are uncorrectable. For example one or more macroblocks are totally lost as the result of the channel 704 experiencing signal fading or any other type of degrading transmission effect.

In one embodiment, the spatial error concealment system 700 comprises physical layer logic 706 that operates to receive the video transmission 702 through the channel 704. The physical layer logic 706 operates to perform demodulation and decoding of the received video transmission 702. For example, in one embodiment, the physical layer logic 706 operates to perform turbo decoding on the received video transmission 702. Thus, in one or more embodiments, the physical layer logic 706 comprises logic to perform any suitable type of channel decoding.

The output of the physical layer logic 706 is input to Stream/MAC layer logic 708. The Stream/MAC layer logic 708 operates to perform any suitable type of error detection and correction. For example, in one embodiment, the Stream/MAC layer logic 708 operates to perform Reed-Solomon Erasure Decoding. The Stream/Mac layer logic 708 outputs a bit stream of decoded video data 710 comprising uncorrectable and/or undetectable errors and in-band error markers. The Stream/Mac layer logic 708 also outputs an error signal 712 that indicates when errors are encountered in one or more of the received macroblocks. In one embodiment, the decoded video data 710 is input to an entropy decoder 714, and the error signal 712 is input to first and second switches (S1 and S2) and SEC logic 726.

The entropy decoder 714 operates to decode the input data stream 710 to produce three outputs. The first output 716 comprises quantization parameters and/or quantized coefficients for blocks associated with macroblocks of the input video data stream 710. The first output 716 is input to a first input of the switch S2. The second output 718 comprises intra prediction directivity modes for blocks associated with macroblocks of the input video data stream 710. The second output 718 is input to a first input of the switch S1. The third output 720 comprises macroblock parameters that are input to a macroblock parameters buffer 724. The macroblock parameters buffer 724 comprises any suitable type of memory device. In one embodiment, the macroblock parameters comprise a macroblock type indicator, intra prediction directivity mode indicators, coefficients, and coefficient indicators that indicate the number of non-zero coefficients for each 4×4 block of each macroblock. In one embodiment, the entropy decoder 714 detects macroblock errors and outputs the error signal 712.

In one embodiment, the SEC logic 726 operates to generate directivity mode information and coefficient parameters for concealment data that is used to conceal errors in the received macroblocks. For example, the error signal 712 from the Stream/MAC layer 708 is input to the SEC logic 726. The error signal 712 indicates that errors have been detected in one or more macroblocks included in the video transmission 702. When the SEC logic 726 receives a selected state of the error signal 712, it accesses the macroblock parameters buffer 724 to retrieve macroblock parameters, as shown at 728. The SEC logic 726 uses the retrieve parameters to generate two outputs. The first output is concealment quantization parameters 730 that are input to a second input of the switch S2. The second output of the SEC logic 726 provides concealment intra directivity modes 732 that are input to a second input of the switch S1. The SEC logic 726 also generates macroblock parameters for the concealed macroblock that are written back into the macro block parameter buffer 724, as shown at 722. A more detailed discussion of the SEC logic 726 is provided in another section of this document.

In one embodiment, the switches S1 and S2 comprise any suitable switching mechanisms that operate to switch information received at a selected switch inputs to switch outputs. For example, the switch S2 comprises two inputs and one output. The first input receives the quantization information 716 from the entropy decoder 714, and the second input receives concealment quantization information 730 from the SEC logic 726. The switch S2 also receives the error signal 712 that operates to control the operation of the switch S2. In one embodiment, if the Stream/MAC layer 708 does not find macroblock errors in the received video transmission 702, then the error signal 712 is output having a first state that controls the switch S2 to select information at its first input to be output at its switch output. If the Stream/MAC layer 708 does find macro block errors in the received video transmission 702, then the error signal 712 is output having a second state that controls the switch S2 to select information at its second input to be output at its switch output. The output of the switch S2 is input to a rescaling block 732.

The operation of the switch S1 is similar to the operation of the switch S2. For example, the switch S1 comprises two inputs and one output. The first input receives intra directivity modes 718 from the entropy decoder 714, and the second input receives concealment intra directivity modes 732 from the SEC logic 726. The switch S1 also receives the error signal 712 that operates to control its operation. In one embodiment, if the Stream/MAC layer 708 does not find macro block errors in the received video transmission 702, then the error signal 712 is output having a first state that controls the switch S1 to select information at its first input to be output at its switch output. If the Stream/MAC layer 708 does find macro block errors in the received video transmission 702, then the error signal 712 is output having a second state that controls the switch S1 to select information at its second input to be output at its switch output. The output of the switch S1 is input to an intra prediction block 734.

In one embodiment, the rescaling block 732 operates to receive quantization parameters for a video signal block and generate a scaled version that is input to an inverse transform block 736.

The inverse transform block 736 operates to process received quantization parameters for the video block signal to produce an inverse transform that is input to summation function 738.

The intra prediction block 734 operates to receive intra directivity modes from the output of switch S1 and neighboring pixel values from a decoded frame data buffer 740 to generate a prediction block that is input to the summing function 738.

The summing function 738 operates to sum the output of the inverse transform block 736 and the output of the prediction block 734 to form a reconstructed block 742 that represents decoded or error concealed pixel values. The reconstructed block 742 is input to the decoded frame data buffer 740 which stores the decoded pixel data for the frame and includes any concealment data generated as the result of the operation of the SEC logic 726.

Therefore in one or more embodiments a spatial error concealment system is provided that operates to detect macroblock errors in a video frame and generate concealment data based on coded macroblock parameters associated with error free macroblocks and/or previously concealed macroblocks.

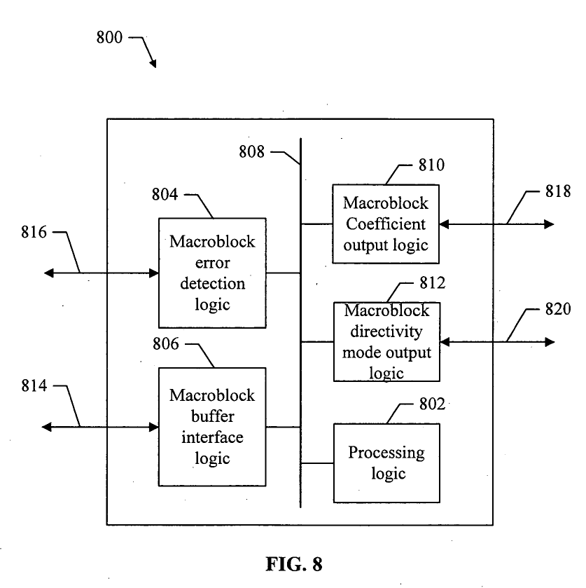

FIG. 8 shows one embodiment of SEC logic 800 suitable for use in one or more embodiments of a spatial error concealment system. For example, the SEC logic 800 is suitable for use as the SEC logic 726 shown in FIG. 7 to provide spatial error concealment for a received video transmission.

The SEC logic 800 comprises processing logic 802, macroblock error detection logic 804, and macroblock buffer interface logic 806 all coupled to an internal data bus 808. The SEC logic 800 also comprises macroblock coefficient output logic 810 and macroblock directivity mode output logic 812, which are also coupled to the internal data bus 808.

In one or more embodiments, the processing logic 802 comprises a CPU, processor, gate array, hardware logic, memory elements, virtual machine, software, and/or any combination of hardware and software. Thus, the processing logic 802 generally comprises logic to execute machine-readable instructions and to control one or more other functional elements of the SEC logic 800 via the internal data bus 808.

In one embodiment, the processing logic 802 operates to process coded macroblock parameters from a macroblock parameters buffer to generate concealment parameters that are used to conceal errors in one or more macroblocks. In on embodiment, the processing logic 802 uses coded macroblock parameters from error free and/or previously concealed macroblocks that is stored in the macroblock parameters buffer to generate directivity mode information and coefficient information that is used to generate the concealment parameters.

The macroblock buffer interface logic 806 comprises hardware and/or software that operate to allow the SEC logic 800 to interface to a macroblock parameters buffer. For example, the macroblock parameters buffer may be the macroblock parameters buffer 724 shown in FIG. 7. In one embodiment, the interface logic 806 comprises logic configured to receive coded macroblock parameters from the macroblock parameters buffer through the link 814. The interface logic 806 also comprises logic configured to transmit coded macroblock parameters associated with concealed macroblocks to the macroblock parameters buffer through the link 814. The link 814 comprises any suitable communication technology.

The macroblock error detection logic 804 comprises hardware and/or software that operate to allow the SEC logic 800 to receive an error signal or indicator that indicates when macroblock errors have been detected. For example, the detection logic 804 comprises logic configured to receive the error signal through a link 816 comprising any suitable technology. For example the error signal may be the error signal 712 shown in FIG. 7.

The macroblock coefficient output logic 810 comprises hardware and/or software that operate to allow the SEC logic 800 to output macroblock coefficients that are to be used to generate concealment data in the video frame. For example the coefficient information may be generated by the processing logic 802. In one embodiment, the macroblock coefficient output logic 810 comprises logic configured to output macroblock coefficients to switching logic, such as the switch S1 shown in FIG. 7.

The macroblock directivity mode output logic 812 comprises hardware and/or software that operate to allow the SEC logic 800 to output macroblock directivity mode values that are to be used to generate concealment data in the video frame. In one embodiment, the macroblock directivity mode output logic 810 comprises logic configured to output macroblock directivity modes values to switching logic, such as the switch S2 shown in FIG. 7.

In one or more embodiments of a spatial error concealment system, the SEC logic 800 performs one or more of the following functions.
a. Receive an error indicator that indicates that one or more unusable macroblocks have been received.
b. Obtain coded macroblock parameters associated with healthy (error free and/or previously concealed) neighbor macroblocks from a macroblock parameters buffer.
c. Generate macroblock directivity mode values and coefficient data for unusable macroblocks.
d. Output the directivity mode values and coefficient data to a decoding system where concealment data is generated and inserted into a decoded video frame.
e. Store coded macroblock parameters for the concealed macroblock back into a macroblock parameters buffer.

In one embodiment, the SEC logic 800 comprises program instructions stored on a computer-readable media, which when executed by at least one processor, for instance, the processing logic 802, provides the functions of a spatial error concealment system as described herein. For example, instructions may be loaded into the SEC logic 800 from a computer-readable media, such as a floppy disk, CDROM, memory card, FLASH memory device, RAM, ROM, or any other type of memory device or computer-readable media. In another embodiment, the instructions may be downloaded into the SEC logic 800 from an external device or network resource that interfaces to the SEC logic 800. The instructions, when executed by the processing logic 802, provide one or more embodiments of a spatial error concealment system as described herein. It should be noted that the SEC logic 800 is just one implementation and that other implementations are possible within the scope of the embodiments.

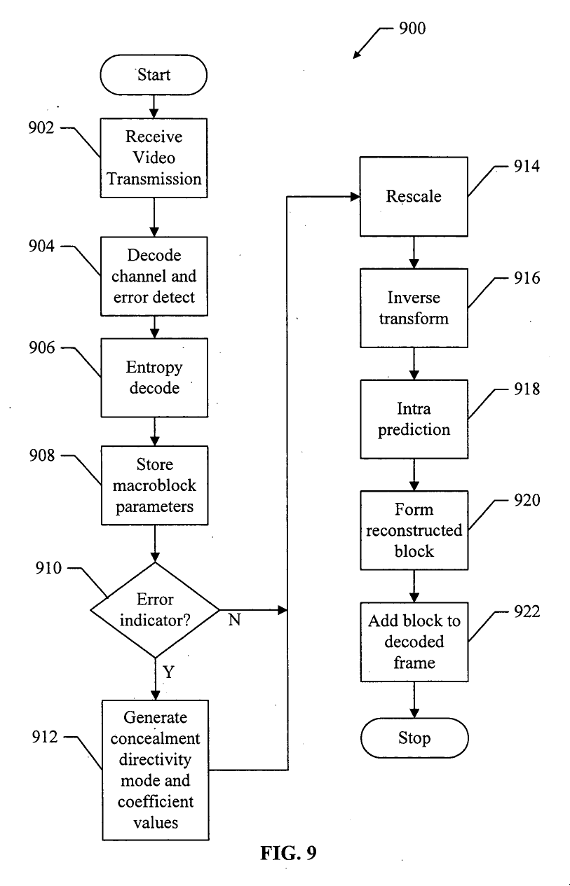

FIG. 9 shows a method 900 for providing one embodiment of spatial error concealment. For clarity, the method 900 is described herein with reference to the spatial concealment system 700 shown in FIG. 7. It should be noted that the method 900 describes one embodiment of basic SEC, while other methods and apparatus described below describe embodiments of enhanced SEC. For example, embodiments of basic SEC provide error concealment based on causal neighbors, while embodiments of enhanced SEC provide error concealment utilizing non-casual neighbors as well. It should also be noted that while the functions of the method 900 are shown and described in a sequential fashion, one or more functions may be rearranged and/or performed simultaneously within the scope of the embodiments.

At block 902, a video transmission is received at a device. For example in one embodiment the video transmission comprises video data frames encoded using H.264 technology. In one embodiment, the video transmission occurs over a transmission channel that experiences degrading effects, such as signal fading, and as a result, one or more macroblocks included in the transmission may be lost, damaged, or otherwise unusable.

At block 904, the received video transmission is channel decoded and undergoes error detection and correction. For example, the video transmission is processed by the physical layer logic 706 and the Stream/Mac layer logic 708 to perform the functions of channel decoding and error detection.

At block 906, the channel decoded video signal is entropy decoded to obtain coded macroblock parameters. For example, in one embodiment, entropy coding comprises a variable length lossless coding of quantized coefficients and their locations. In one embodiment, the entropy decoder 714 shown in FIG. 7 performs entropy decoding. In one embodiment, the entropy decoding may also detect one or more macroblock errors.

At block 908, coded macroblock parameters determined from the entropy decoding are stored in a macroblock parameters buffer. For example, the macroblock parameters may be stored in the buffer 724 shown in FIG. 7. The macroblock parameters comprise block directivity mode values, transform coefficients, and non-zero indicators that indicate the number of non-zero coefficients in a particular block. In one or more embodiments, the macroblock parameters describe both luminance (luma) and/or chrominance (chroma) data associated with a video frame.

At block 910, a test is performed to determine if one or more macroblocks in the received video transmission are unusable. For example, data associated with one or more macroblocks in the received video stream may have been lost in transmission or contain uncorrectable errors. In one embodiment, macroblock errors are detected at block 904. In another embodiment, macroblock errors are detected at block 906. If no errors are detected in the received macroblocks, the method proceeds to block 914. If errors are detected in one or more macroblocks, the method proceeds to block 912.

At block 912, concealment parameters are generated from error free and/or previously concealed neighbor macroblocks. For example, the concealment parameters comprise directivity mode values and transform coefficients that can be used to produce concealment data. In one embodiment, the concealment parameters are generated by the SEC logic 800 shown in FIG. 8. The SEC logic 800 operates to receive an error signal that identifies an unusable macroblock. The SEC logic 800 then retrieves coded macroblock parameters associated with healthy neighbor macroblocks. The macroblock parameters are retrieved from a macroblock parameters buffer, such as the buffer 724. The neighbor macroblocks were either accurately received (error free) or were previously concealed by the SEC logic 800. Once the concealments parameters are generated, they are written back into the macroblock parameters buffer. In one embodiment, the transform coefficients generated by the SEC logic 800 comprise all zeros. A more detailed description of the operation of the SEC logic 800 is provided in another section of this document.

At block 914, the transform coefficients associated with a macroblock are rescaled. For example, rescaling allows changing between block sizes to provide accurate predictions. In one embodiment, the coefficients are derived from healthy macroblocks that have been received. In another embodiment, the coefficients represent coefficients for concealment data and are generated by the SEC logic 800 as described at block 912. The resealing may be performed by the rescaling logic 732 shown in FIG. 7.

At block 916, an inverse transform is performed on the coefficients that have been rescaled. For example, the inverse transform is performed by the inverse transform logic 736 shown in FIG. 7.

At block 918, an intra_{—}4×4 prediction block is generated using the directivity mode value and previously decoded frame data. For example, the directivity mode value output from the switch S1 shown in FIG. 7 is used together previously decoded frame data to produce the prediction block.

At block 920, a reconstructed block is generated. For example, the transform coefficients generated at block 916 are combined with the prediction block produced at block 918 to generate the reconstructed block. For example, the summing logic 738 shown in FIG. 7 operates to generate the reconstructed block.

At block 922, the reconstructed block is written to into a decoded frame buffer. For example, the reconstructed block is written into the decoded from buffer 740 shown in FIG. 7.

Thus, the method 900 operates to provide spatial error concealment to conceal damaged macroblocks received at a playback device. It should be noted that the method 900 is just one implementation and that additions, changes, combinations, deletions, or rearrangements of the described functions may be made within the scope of the embodiments.

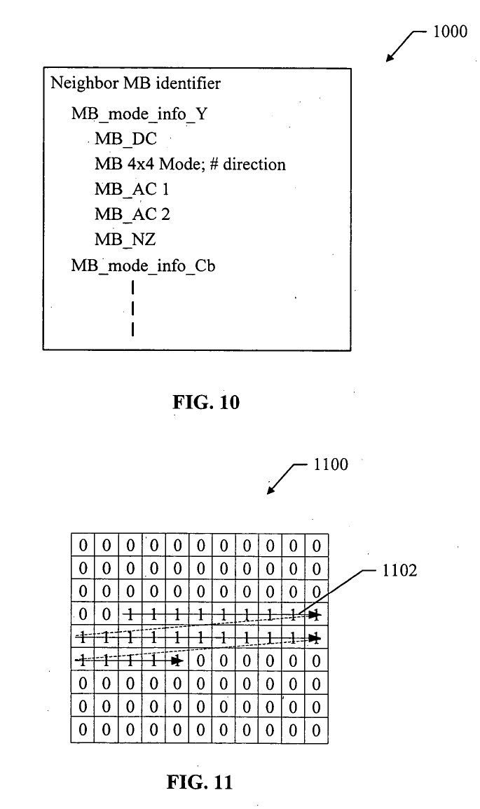

FIG. 10 shows one embodiment of a macroblock parameters buffer 1000 for use in one embodiment of a spatial error concealment system. For example, the buffer 1000 is suitable for use as the buffer 724 shown in FIG. 7. The parameters buffer 1000 comprises coded parameter information that describes macroblocks associated with a received video transmission. For example, the information stored in the buffer 1000 identifies macroblocks and macroblock parameters, such as luma and/or chroma parameters comprising DC value, mode, directivity information, non-zero indicator, and other suitable parameters.

Concealment Algorithm

In one or more embodiments of the spatial error concealment system, an algorithm is performed to generate concealment data to conceal lost or damaged macroblocks. In one embodiment, the algorithm operates to allow the spatial error concealment system to adapt to and preserve the local directional properties of the video signal to achieve enhanced performance. A detailed description of the algorithm and its operation is provided in the description below.

The system operates with both intra_{—}16×16 and intra_{—}4×4 prediction modes to utilize (healthy) neighboring macroblocks and their 4×4 blocks to infer the local directional structure of the video signal in the damaged macroblock. Consequently, in place of the erroneous/lost macroblocks, intra_{—}4×4 coded concealment macroblocks are synthesized for which 4×4 block intra prediction modes are derived coherently based on available neighbor information.

The intra_{—}4×4 concealment macroblocks are synthesized without residual (i.e. coefficient) data. However, it is also possible to provide residual data in other embodiments for enhancing the synthesized concealment macroblocks. This feature may be particularly useful for incorporating corrective luminance and color information from available non-causal neighbors.

Once the synthesized concealment macroblocks are determined, they are simply passed to the regular decoding system or logic at the playback device. As such, the implementation for concealment is streamlined and is more like a decoding process rather than being a post-processing approach. This enables simple and highly efficient porting of the system to targeted playback platforms. Strong de-blocking filtering, executed in particular across the macroblock borders marking the loss region boundaries, concludes the concealment algorithm.

It should be noted that many variations on the basic algorithmic principles are possible, in particular with respect to the order in which concealment macroblocks and their 4×4 blocks are synthesized. However, the following descriptions reflect functions and implementation selections made to accommodate and/or match the structure and/or constraints of a wide range of targeted hardware/firmware/software platforms.

Inputs to the Algorithm

In one or more embodiments, the spatial concealment algorithm utilizes two types of inputs as follows.

Loss Map

The loss map is a simple 1 bit per macroblock binary map generated by the macroblock error detection process described above. All macroblocks either corrupted by error or skipped/missed during the resynchronization process, and therefore needing to be concealed, are marked with ‘1’s. The remaining macroblocks are marked with ‘0’s.

FIG. 11 shows one embodiment of a loss map 1100 for use in one embodiment of a spatial error concealment system. The loss map 1100 illustrates a map of macroblocks associated with a video frame where healthy macro blocks are marked with a “0” and corrupted or lost macroblocks are marked with a “1.” The loss map 1100 also illustrates a direction indicator 1102 that shows the order in which macroblock are processed in one embodiment of a spatial error concealment system to generate concealment data.

Healthy Neighbor Information

The following identifies three classes of information from healthy neighbors that are used in the concealment algorithm to generate concealment data in one embodiment of a spatial error concealment system.
a. Macroblock coding type (either intra_{—}1 6×16 or intra4×4)
b. If the macroblock coding type is intra_{—}16×16, then the intra_{—}16×16 prediction (directivity) mode is used. If the macroblock coding type is intra_{—}4×4, then the constituent 16 intra_{—}4×4 prediction (directivity) modes are used.
c. Nonzero indicator that indicates the number of (non-zero) coefficients for each constituent 4×4 block.
   These pieces of information are accessed through the data structures stored in the macroblock parameters buffer, for example, the buffer 724 shown in FIG. 7.
   Order of Processing at the Macroblock Level

In one embodiment, only information from the available causal neighbors is used. However, in other embodiments, it is also possible to incorporate information from the non-causal neighbors as well. Thus, in accordance with the causal structure of the utilized neighbors, the concealment macroblock processing/synthesis order obeys the raster scan pattern, (i.e. from left to right and top to bottom), as illustrated in FIG. 11. Once invoked with a particular loss map, the spatial concealment process starts scanning the loss map one macroblock at a time in raster scan order, and generates concealment data for the designated macroblocks one at a time in the order shown.

Utilized Neighbors at the Macroblock Level

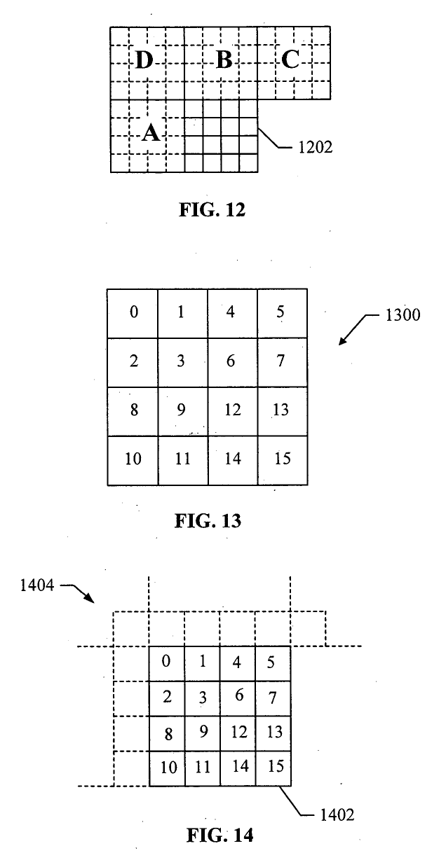

FIG. 12 shows one embodiment of a macroblock 1202 to be concealed and its four causal neighbors (A, B, C, and D). One condition for neighbor usability is its ‘availability’ where availability is influenced/defined by the position of the concealment macroblock relative to the frame borders. Neighboring macroblocks types or slice associations are of no consequence. Hence for example, concealment macroblocks not located along frame borders have all four of their neighbor macroblocks available, whereas concealment macroblocks positioned on the left border of the frame have their neighbors A and D unavailable.

FIG. 13 shows a macroblock 1300 that illustrates an order in which the concealment process scans all 16 intra_{—}4×4 blocks of each concealment macroblock to determine intra_{—}4×4 prediction (directivity) modes for each block. For example, the macroblock 1300 shows an order indicator associated with each block.

Utilized Neighbors at the 4×4 Block Level

FIG. 14 shows a macroblock to be concealed 1402 and ten blocks from neighbor macroblocks (shown generally at 1404) to be used in the concealment process. The spatial error concealment algorithm preserves the local directional structure of the video signal through propagating the directivity properties inferred from the available neighbors to the macroblock to be concealed. This inference and propagation takes place at the granularity of the 4×4 blocks. Hence, for each 4×4 block to be concealed, a collection of influencing neighbors can be defined.

In case of influencing 4×4 neighbors that are part of the external neighbors at the macroblock level, the availability attribute is inherited from their parents. For example, such a 4×4 block and its associated information are available if its parent is available as defined above.

In case of influencing 4×4 neighbors which are part of the macroblock to be concealed, the availability is defined with respect to the processing order of the macroblock as described with reference to FIG. 13. Thus, a 4×4 potential influencing neighbor is available if it is already encountered and processed in the 4×4 block scan order, otherwise it is unavailable.

Directivity Information Propagation and intra_{—}4×4 Prediction Mode Determination

The first step in concealment macroblock synthesis is mapping the macroblock type and intra prediction mode information associated with 10 external influencing 4×4 neighbors (derived from four different macroblock neighbors), to corresponding appropriate intra_{—}4×4 prediction modes.

In one embodiment, the mapping process is trivial (identity mapping) if the external influencing 4×4 neighbor belongs to an intra_{—}4×4 coded macroblock. For all other (parent) macroblock types, the mapping rules are defined as follows.

| Parent MB Type | Substitute 4 × 4 Prediction |
|---|---|
| and Prediction Mode | Mode for Blocks |
| Intra_16 × 16, Vertical | mode 0 if Parent = B; |
| | mode 2 (DC) otherwise |
| Intra_16 × 16, Horizontal | mode 1 if Parent = A; |
| | mode 2 (DC) otherwise |
| Intra_16 × 16, DC | mode 2 (DC) |
| Intra_16 × 16, Plane | mode 2 (DC) |
| All others MB types | mode 2 (DC) |
| (excluding Intra_4 × 4) | |

In one embodiment, it is possible to increase the smoothness of the concealment result across macroblock boundaries and hence improve the subjective quality by letting all external parent macroblock types' mapping, except for Intra_{—}4×4 and Intra_{—}16×16 types, be a function of the parent macroblock location. For example, let the substitution rule in the last entry above be changed to;
mode 0 if parent=B; mode 1 if parent=A; and mode 2 (DC) otherwise.
   Cliques

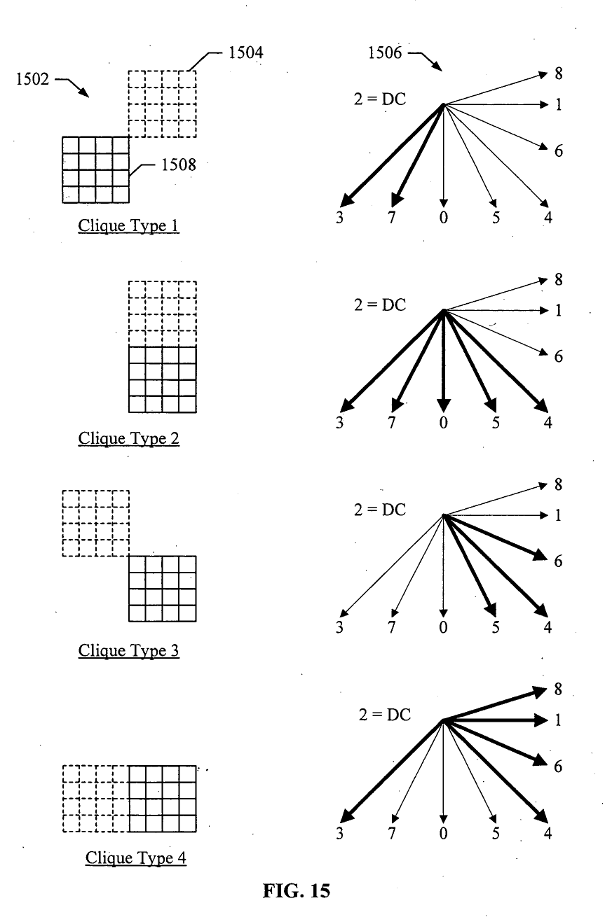

FIG. 15 shows one embodiment of four clique types (1-4) that describe the relationship between 4×4 neighbor blocks and a 4×4 block to be concealed. For example, each of the four influencing 4×4 neighbors (A, B, C, D) identified in FIG. 12 together with the 4×4 block 1202 to be concealed can be used to define a specific clique type. Cliques are important because their structures have a direct impact on the propagation of directivity information from influencing neighbor blocks to the 4×4 block to be concealed.

Clique type 1 is shown generally at 1502. The influencing 4×4 neighbor 1504 in this clique (and for that mailer in all cliques), can have an intra_{—}4×4 prediction mode classification given by one out of the 9 possibilities illustrated at 1506. The influencing 4×4 neighbor 1504 being classified into one of the 8 directional prediction modes i.e. {0,1,3,4,5,6,7,8}, implies that there is some form of a directional structure (i.e., an edge or a grating) that runs parallel to the identified directional prediction mode. Note the mode 2 does not imply a directional structure, and therefore will not influence the directional structure of the 4×4 block to be concealed.

Owing to the relative position of the influencing 4×4 neighbor 1504 with respect to the 4×4 block 1508 to be concealed, not all directional structures present in the influencing neighbor are likely to extend into or continue in and influence the 4×4 block 1508 to be concealed. In fact, only directional structures parallel to the darkened directional indicators illustrated in the modes at 1506 have a potential to influence the 4×4 block 1508 to be concealed. Thus, clique type 1 allows propagation of only modes 3 and 7 from the influencing 4×4 neighbor 1504 to the 4×4 block 1508 to be concealed. As such, it can be said that cliques define directivity propagation filters, allowing certain modes and stopping certain other modes. Thus, FIG. 15 illustrates the four clique types (1-4) and darkened directional indicators show the associated allowable modes for each type.

Determining Contributions to Concealment Directivity

The intra_{—}4×4 prediction modes of influencing neighbors, which are allowed to propagate based on the governing cliques, jointly influence and have a share in determining (i.e. estimating), the directional properties of the 4×4 block to be concealed. The process through which the resultant directivity attribute is calculated as a result of this joint influence from multiple influencing neighbors can be described as follows.

Each of the 8 directional intra_{—}4×4 prediction modes illustrated in FIG. 15 (i.e. all modes except for the DC mode), can be represented by a unit vector described by;
cos θi+sin θj
   and oriented in the same direction as its descriptive directional arrow. In this case, θ is the angle that lies between the positive sense of the x-axis and the directional arrow associated with anyone of the eight modes. Unit vectors i and j represent unit vectors along the x-axis and y-axis, respectively. The DC mode (mode 2) is represented by the zero vector 0i+0j.

If for a particular 4×4 block, the specified intra_{—}4×4 prediction mode is indeed a very good match in capturing the directional structure within this 4×4 region, it is expected that the prediction based on this mode will also be very successful leading to a very ‘small’ residual. Exceptions to this may occur in cases where the directivity properties of the signal have discontinuities across the 4×4 block boundaries. Under the above favorable and statistically much more common circumstances, the number of non-zero coefficients resulting from the transform and quantization of the residual signal will also be very small. Hence the number of non-zero coefficients associated with an intra_{—}4×4 coded block can be used as a measure of how accurately the specified prediction mode matches the actual directional structure of the data in the block. To be precise, an increasing number of non-zero coefficients corresponds to a deteriorating level of accuracy with which the chosen prediction mode describes the directional nature of the 4×4 block.

In one embodiment, the directivity suggesting individual contributions of the influencing neighbors are represented as unit vectors and added together (in a vector sum) so as to produce a resultant directivity. However, it is desirable to weigh the more accurate directivity information more heavily. In order to achieve this, a positive, non-increasing function on the set N={0, 1, 2, 3 . . . 16} of all allowable values for the parameter “number of non-zero coefficients” is defined. In one embodiment, this function is given by;
w(n)={10, 7, 5, 3, 3, 1, 1, 0.5, 0.5, 0.5, 0.5, 0.5, 0.5, 0.5, 0.5, 0.5, 0.5}

The above function will yield the weights in the vector sum. It should be noted that smaller “number of non-zero coefficients” lead to larger weights and vice-versa.

Based on the above information, the calculation which yields the resultant directivity (i.e. the estimated directivity for a 4×4 block to be concealed), can be expressed as follows;

$${d}^{->} = {\sum }_{i} w ( {n}_{i} ) • \hat{u} ( {p}_{i} )$$

The final step of the process to determine the directivity structure for the 4×4 block to be concealed is to quantize the resultant vector \vec{d}.

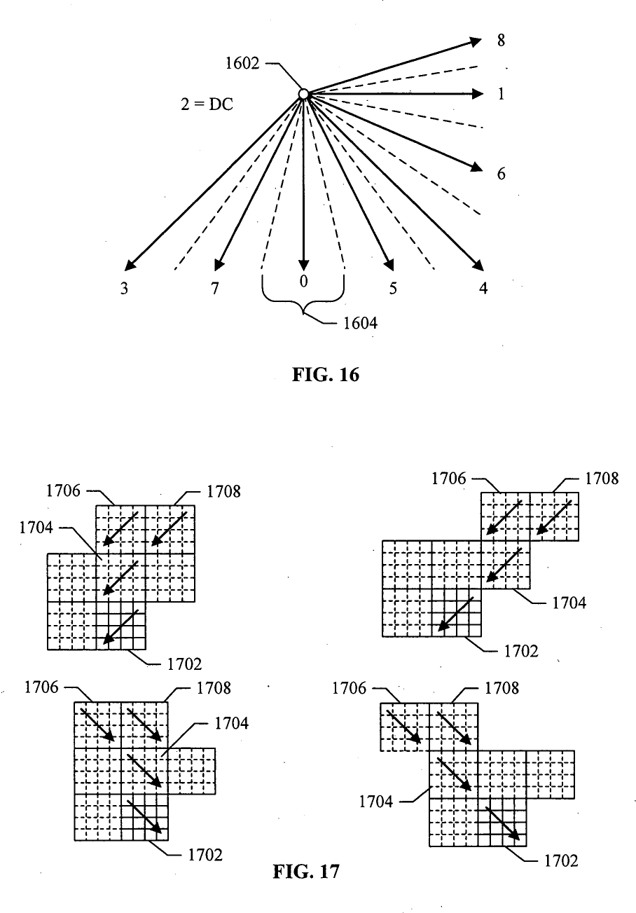

FIG. 16 shows a mode diagram that illustrates the process of quantizing the resultant directional vector \vec{d}. In one embodiment, the processing logic 802 comprises quantizer logic that is configured to quantize the resultant vector described above. The quantizer logic comprises a 2-stage quantizer. The first stage comprises a magnitude quantizer that classifies its input as either a zero vector or a non-zero vector. A zero vector is represented by the circular region 1602 and is associated with prediction mode 2. A non-zero vector is represented by the vectors outside the circular region 1602 and is associated with prediction modes other than 2. For non-zero outputs from the first stage, the second stage implements a phase quantization to classify its input into one of the 8 directional intra_{—}4×4 prediction modes (i.e., wedge shaped semi-infinite bins). For example, resultant vectors in the region 1604 would be quantized to mode 0 and so on.

Although, embodiments of the above process provide a concealment result for the majority of 4×4 blocks to be concealed, there are situations where the output (i.e. the final classification), needs to be readjusted. These situations can be grouped under two categories, namely; “Propagation Rules” and “Stop Rules.”

Propagation Rule #1: Diagonal Classification Consistency

FIG. 17 illustrates one embodiment of propagation Rule #1 for diagonal classification consistency in one embodiment of a spatial error concealment system. Rule #1 requires that for a diagonally (down-left or down-right) predicted external influencing neighbor to determine the final classification for a 4×4 block to be concealed, the influencing neighbor should have identically oriented neighbors itself. Thus, in four situations shown in FIG. 17, the block to be concealed is shown at 1702 and its external influencing neighbor is shown at 1704. In accordance with Rule #1, the neighbor 1704 should have either of its neighbors 1706, 1708 with the same orientation.

Rule #1 may be utilized in situations in which the common rate-distortion criterion based mode decision algorithms fail to accurately capture 4×4 block directivity properties. In one embodiment, Rule #1 is modified to support other non-diagonal directional modes. In another embodiment, Rule #1 is conditionally imposed only when the number of nonzero coefficients associated with the external influencing neighbor is not as small as desired (i.e., not a high-confidence classification).

Propagation Rule #2: Generation Differences

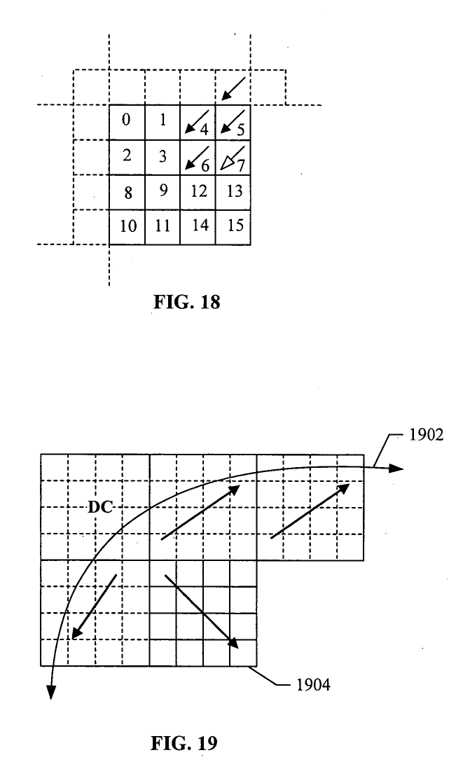

FIG. 18 illustrates one embodiment of propagation Rule #2 for generational differences in one embodiment of a spatial error concealment system. Rule #2 pertains to constraining the manner in which directional modes propagate (i.e. influence their neighbors), across generations within the 4×4 blocks of a macroblock to be concealed. A generation attribute is defined on the basis of the order of the most authentic directivity information available in a 4×4 block's neighborhood; precisely, it is given as this value plus 1. By definition, the (available) external neighbors of a macroblock to be concealed are of generation 0. Hence in FIG. 18, since both of the 4×4 blocks with indices 4 and 5 have 0^{th} generation neighbors; both of these blocks are in generation 1.

As illustrated in FIG. 18, it will be assume that both 4×4 blocks with indices 4 and 5 have final classifications given by diagonal_down_left, fundamentally owing to their illustrated (with a solid black arrow) common external neighbor with the same prediction mode.

Under previously described circumstances, the diagonal_down_left classification for the 4×4 block with index 5 would have influenced its two neighbors, namely; the 4×4 blocks with indices 6 and 7. However, under the constraints of Rule #2, the 4×4 block with index 5 is allowed to propagate its directivity information only to its neighboring 4×4 block with index 6, which lies along the exact direction as the directivity information to be propagated. As illustrated with an open arrowhead, propagation of diagonal_dawn_left directivity information from the 4×4 block with index 5 to the 4×4 block with index 7 is disabled.

Propagation Rule #3: Obtuse Angle Defining Neighbors

FIG. 19 illustrates one embodiment of propagation Rule #3 for obtuse angle defining neighbors in one embodiment of a spatial error concealment system. Owing fundamentally to the phase discontinuity between the two unit vectors representing intra_{—}4×4 prediction modes 3 and 8, there occur neighborhoods in which in spite of an edge gracefully changing its orientation, the resultant directivity classification turns out to be totally unexpected: almost locally perpendicular to the edge. For example, a local edge boundary is shown at 1902 and concealment block 1904 comprises a resultant directivity classification that is approximately perpendicular to the edge 1902.

In one embodiment, it is possible to detect such neighborhood instances through calculating the phase difference between the prediction modes of the two influencing neighbors that have the largest phase separation. In another embodiment, it is possible to evaluate the maximum phase difference between the final classification and any one of the contributing neighbors. In either case, when an obtuse angle defining neighbor configuration is detected, the final classification result is changed appropriately.

Stop Rule #1: Manhattan Corners

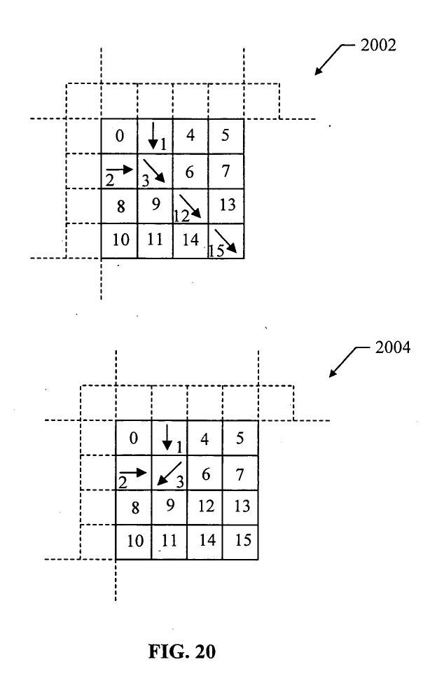

FIG. 20 illustrates one embodiment of stop Rule #1 pertaining to Manhattan corners in one embodiment of a spatial error concealment system. Referring to block 2002 and the 4×4 block with index 3, assuming (number of non-zero coefficients based) weights of the same order, the illustrated directivity influences from the above and the left neighbors (i.e. modes 0 (vertical) and 1 (horizontal)) respectively, with no other significant directivity influence from the remaining neighbors, would have resulted in mode 4 (diagonal-down-right) as the final directivity classification (i.e. prediction mode) for this block.

Directivity information associated with the 4×4 block with index 3, would consequently have influenced at least the 4×4 block with index 12, and very likely also the 4×4 block with index 15, if it had dominated the classification for the block with index 12. Beyond its propagation and potential influence, assuming sufficiently large weights, mode 4 influence will dominate the classification for blocks (with indices) 12 and 15 leading to a significant distortion of the actual corner.

In order to avoid this undesirable behavior, one embodiment of Stop Rule #1 operates to classify the 4×4 block with index 3 as a diagonal_down_left block as illustrated at block 2004, the influence of which does not propagate to any of its neighbors (hence the term “stop rule”).

Concealment of Chroma Channel Blocks

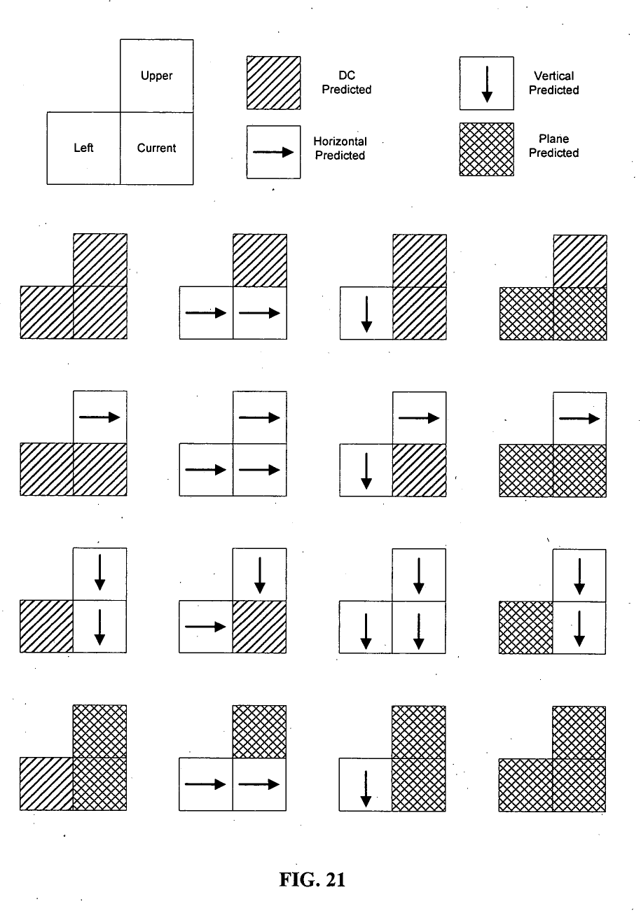

FIG. 21 illustrates the operation of one embodiment of a spatial concealment algorithm for concealing lost chrominance (Cb and Cr) channel 8×8 pixel blocks. In one embodiment, this algorithm utilizes only the causal two neighbors' (i.e. upper and left neighboring chroma blocks), (intra) chroma prediction mode information to infer an appropriate directivity classification, and therefore a chroma prediction mode for the chroma block to be concealed. For example, a variety of examples are shown to illustrate how upper and left neighboring chroma blocks are used to determine a chroma prediction mode for a chroma block to be concealed.

Enhanced Version of SEC Using Non-causal Neighbor Information

In one embodiment, utilization of more spatial information (luma, chroma, and directivity) from regions surrounding the lost area, improves the quality of spatial concealment algorithms by enabling them to restore the lost data more accurately. Therefore, in order to utilize information from the non-causal neighbors for spatial concealment two techniques are described below.

Mean Brightness and Color Correction in the Lower Half of Concealed Macroblocks

When information from only causal neighbors is used in SEC as described above, the resulting concealment may have a brightness (luma channel) and/or color (chroma channels) mismatch along the border of the concealed area with its non-causal neighbors. This is easy to understand given the constraint on the utilized information. Hence, one immediate opportunity for enhancing the quality of the concealment is avoiding these gross mismatches. This enables better blending of the concealed region with its entire periphery/surrounding, and consequently reduces its visibility. It is important to note that, the use of information from non-causal neighbors also leads to considerable improvements with respect to objective quality metrics.

As described above, one embodiment of the SEC algorithm relies on zero-residual intra_{—}4×4 decoding. For each macroblock to be concealed, the SEC process generates an intra_{—}4×4 coded macroblock object (the so called ‘concealment macroblock’) for which the 16 intra_{—}4×4 prediction modes associated the luma channel are determined on the basis of directivity information available from the causal neighbors' luma channel. In a similar fashion, the chroma channels' (common) intra prediction mode for the concealment macroblock is determined on the basis of directivity information available from the causal neighbors' chroma channels. In one embodiment, an enhancement to this design is the introduction of a preliminary processing stage which will analyze and synthesize directivity properties for the macroblock to be concealed in a unified manner based on information extracted from available (causal) neighbors' both luma and chroma channels jointly.

Once the intra_{—}4×4 prediction modes and the chroma intra prediction mode are determined for the concealment macroblock, it is presented to the regular decoding process with no residual data. The decoder output for the concealment macroblock provides the baseline spatial concealment result.

In the enhancement described in this subsection, the above described baseline (zero-residual) concealment macroblock is augmented with some residual information in order to avoid gross brightness and/or color mismatches along its borders with its non-causal neighbors. Specifically, residual data consisting of only a quantized DC coefficient is provided for luma 4×4 blocks in the lower half of the concealment macroblock.

FIG. 22 shows a diagram of luma and chroma (Cr, Cb) macroblocks to be concealed in one embodiment of an enhanced spatial error concealment system. As shown in FIG. 22 residual data consisting of only a quantized DC coefficient is provided for luma 4×4 blocks in the lower half of the concealment macroblock (i.e. for luma blocks having indices in the range 8 to 15, inclusive). In an analogous manner, in both chroma channels the 4×4 blocks with indices 2 and 3 are augmented with DC-coefficient-only residuals. Both for the luma channel and the chroma channels, the corrective DC values are calculated with respect to the mean (brightness and color) values of non-causal neighboring 4×4 blocks lying vertically below. The details of this enhanced algorithm are provided in the following sections.

Enhanced Loss Map Generation

As before, the first action of the algorithm upon recovery (i.e. detection and resynchronization), from an error in the bitstream, is the identification of the loss extent (i.e. the generation of the loss map).

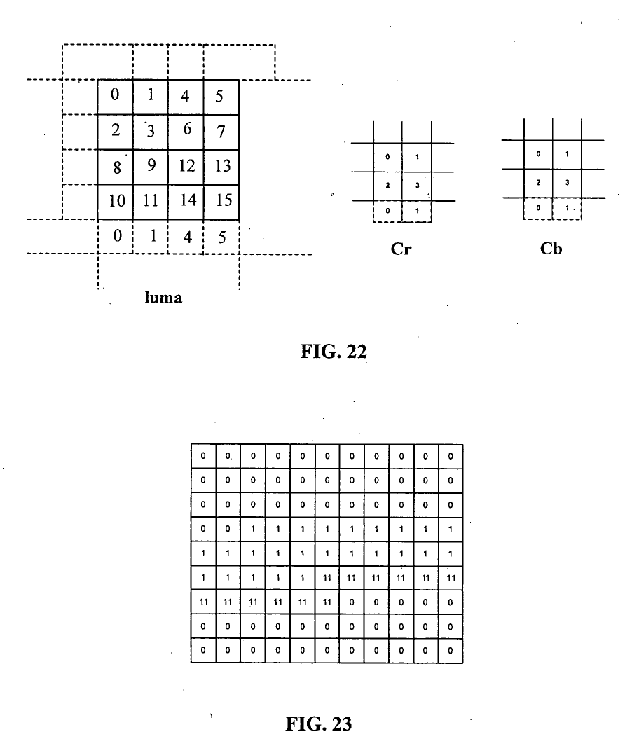

FIG. 23 shows one embodiment of an enhanced loss map. In order to support the use of information from available non-causal neighbors in the concealment process, the enhanced loss map introduces two new macroblock mark-up states, ‘10’ and ‘11’, in addition to the two states, ‘0’ and ‘1’, of the basic loss map described with reference to FIG. 11.

As illustrated in FIG. 23, when the loss map is generated for the first time immediately after recovering from a bitstream error, the decoder also marks-up all macroblocks which are non-causal neighbors of the loss region, with state ‘11’. Since at this point, information from these non-causal neighboring macroblocks is not yet available to the decoder; the enhanced spatial concealment process cannot commence and has to be delayed.

As the decoding process encounters and successfully decodes data for the marked-up non-causal neighbors of the loss region, it changes their state from ‘11 ’ to ‘10’ in the enhanced loss map, finally converting the loss map shown in FIG. 23 to the one illustrated in FIG. 24. A mark-up value of ‘10’ indicates that causal information required by SEC logic is available for that particular macroblock.

When can Enhanced Spatial Concealment Occur?

For lost/erroneous macroblocks that do not have any available non-causal neighbors, the spatial concealment process described above can immediately commence. For lost/erroneous macroblocks which have one or more available non-causal neighbors, the following actions may be taken to provide enhanced spatial concealment.

1. A concealment macroblock can be synthesized as soon as the preliminary decoding processing (i.e. macroblock packet generation, on all of its available non-causal neighbors), is completed. This will reduce the latency in generating concealment macroblocks. However, the frequent switching between preliminary decoding and concealment contexts may result in considerable instruction cache trashing reducing the execution efficiency of this operation mode.

2. Concealment macroblocks can be synthesized altogether as soon as the preliminary decoding processing on all of the originally marked-up (with a value of ‘11’) non-causal neighboring macroblocks is finished, without waiting for the completion of the current slice's decoding. In terms of concealment latency and execution efficiency, this approach may offer the best trade-off. This action may require the inspection of the loss map after the preliminary decoding of each macroblock.

3. Concealment macroblocks can be synthesized altogether when the preliminary decoding process for the (entire) slice containing the last of the originally marked-up non-causal neighboring macroblocks is finished. This may undesirably increase the latency of generating the concealment macroblocks. However, in terms of implementation complexity and execution efficiency, it may provide the simplest and the most efficient approach.

Choice of QP_{Y} for the Concealment Macroblocks

The presence of residual data in a concealment macroblock synthesized by the SEC algorithm implies the necessity of assigning a QP_{Y} value (quantization parameter relative to luma) to this macroblock and also the necessity of providing the residual information at this quantization level. In the basic version of SEC, since there is no residual data in concealment macroblocks there is no need to address QP_{Y}. This is also true in the enhanced version of SEC for those macroblocks that do not have any available non-causal neighbors.

Regarding the choice of QP_{Y} for a concealment macroblock with one or more available non-causal neighbors, the following two choices are available:
1. The concealment macroblock can inherit the QP_{Y} value of its immediately below non-causal neighbor.

2. The QP_{Y} value for the concealment macroblocks can be uniformly set to a relatively high value to enforce a strong deblocking filtering operation taking place inside these macroblocks. In particular in the enhanced SEC design, this will enable some smoothing vertically across the equator of the concealed macroblocks where potentially differing brightness and color information propagated from causal and non-causal neighbors meet. Strong deblocking filtering in particular in this region is expected to improve both subjective and objective concealment performance.

High-level Structure of Enhanced SEC

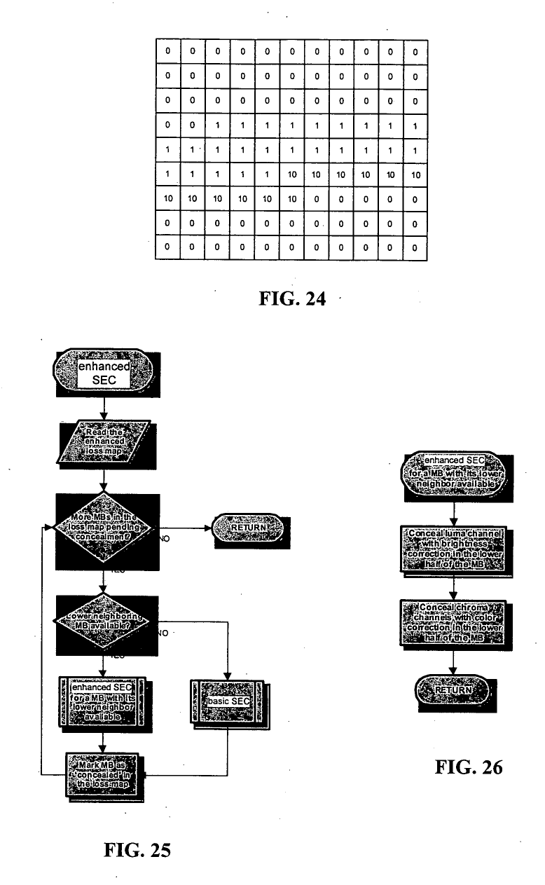

FIG. 25 provides one embodiment of a method for providing enhanced SEC. Enhanced SEC provides an enhancement on top of the basic version of SEC and is activated only when a concealment macroblock has its below neighbor available. This will not be the case when the neighboring macroblock below is also lost or does not exist (i.e. the macroblock to be concealed is above lower frame boundary). Under these circumstances, the enhanced SEC will act just like the basic version of SEC.

It should be noted that it is possible to extend the basic approach of the enhanced SEC described herein to achieve a similar brightness and color correction in the right half of a concealment macroblock for which the right neighbor is available.

FIG. 26 provides one embodiment of a method for determining when it is possible to utilize enhanced SEC features.

Mean Brightness Correction in the Luma Channel

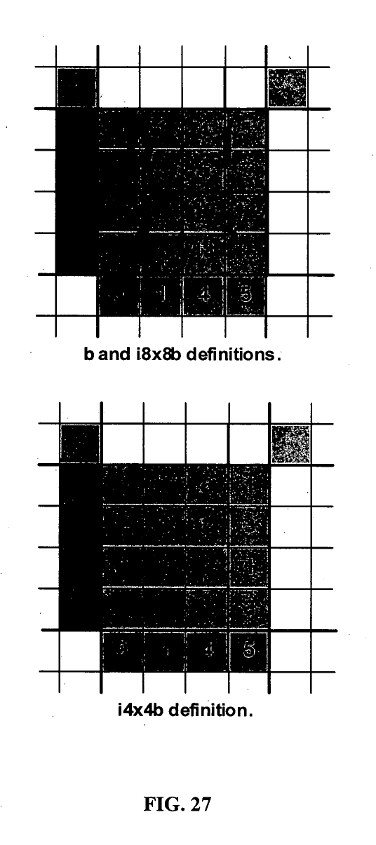

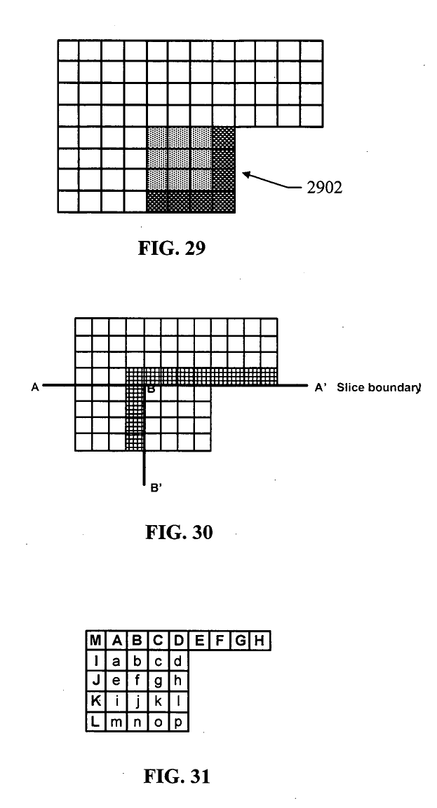

FIG. 27 illustrates definitions for variables used in a method for achieving mean brightness correction in one embodiment of an enhanced SEC system. FIG. 29 shows a block and identifies seven (7) pixels 2902 used for performing intra_{—}4×4 predictions on neighboring 4×4 blocks.

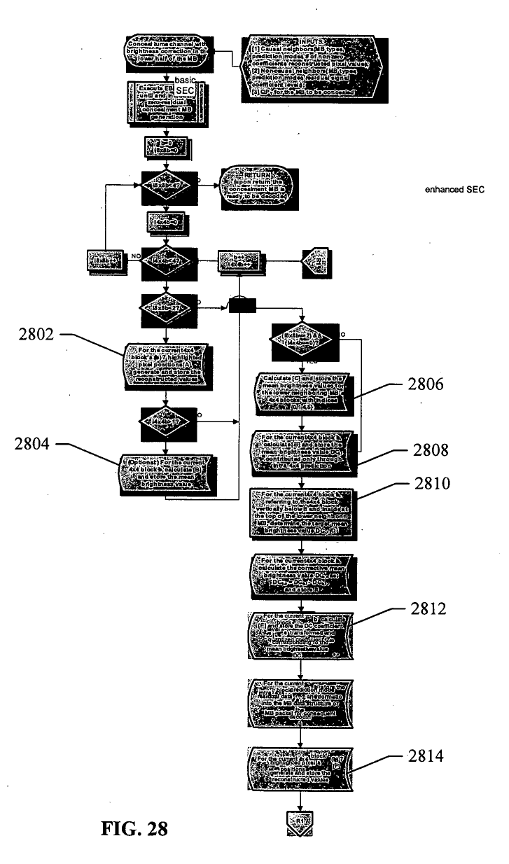

FIG. 28 shows one embodiment of a method that provides an algorithm for achieving mean brightness (i.e. luma channel), correction in the lower half of a concealment macroblock in one embodiment of an enhanced SEC.

At block 2802, in each 4×4 block of the concealment macroblock, the calculation of only these seven highlighted pixel values is sufficient to recursively continue calculating;
a. all (16) pixels values and in particular the corresponding (to the highlighted ones) subset of seven values,
b. the mean brightness value exactly (based on all pixel values) or approximately (through the use of a single inter_{—}4×4 prediction mode based formula, see below),
   for all consequent 4×4 blocks in the sane MB and in H.264 specified 4×4 block scan order.

At blocks 2804 and 2808, the mean brightness value for an intra_{—}4×4 predicted block can be exactly calculated in a trivial manner through first calculating all of the 16 individual pixel values in that 4×4 block and then taking the average of all 16 (followed by appropriate rounding for our purposes). However, there is also a simpler, faster but approximate way of calculating the same quantity. This approach requires the use of 8+3 different (simple) formulae each associated with a particular intra_{—}4×4 prediction mode. Although the derivations of these formulae are not difficult, some attention paid to rounding details will improve their accuracy.

At block 2806, calculation of the mean brightness values for the lower neighboring macroblock's uppermost 4×4 blocks, namely those with scan indices {0, 1, 4, 5}, require some decoding processing to occur. A framework for achieving this in a very fast manner and with very low complexity through efficient, partial decoding is presented in another section below. Given this framework, two possible different ways of calculating this mean are provided below.

In one case, through the combined use of the mean brightness component contributed by the intra prediction mode governing the 4×4 block, as well as the remaining component contributed by the residual signal's DC coefficient, this mean can be calculated as an average quantity across the entire 4×4 block. However, when the 4×4 block contents in the pixel domain are not uniform (e.g. a horizontal or oblique edge, or some texture), the resulting mean will not provide a satisfactory input to the described brightness correction algorithm since it will not be representative of any section of the 4×4 block.

In the other case, instead of calculating the mean brightness over the entire 4×4 block, an average brightness is calculated only over the topmost row of 4 pixels of the 4×4 block that are closest to and hence correlate best with the area where the brightness correction will take place.

At block 2810, for blocks 8 and 10 of the concealment macroblock, this is block 0 of the lower neighbor; for blocks 9 and 11 of the concealment macroblock, this is block 1 of the lower neighbor; for blocks 12 and 14 of the concealment macroblock, this is block 4 of the lower neighbor; and for blocks 13 and 15 of the concealment macroblock, this is block 5 of the lower neighbor.

The manner in which brightness correction can happen for blocks {8, 9, 12, 13}, more accurately the target mean brightness value for these blocks, is open to some possibilities. Two possibilities are described below.

In one case, the target mean brightness values can be taken directly as the mean brightness values of the lower neighbor's corresponding 4×4 blocks. In this case, enforcing a strong deblocking filtering in particular vertically across the equator of the concealment MB is highly recommended.

As an alternative, the target mean brightness value for say block 8, can be taken as the average of the mean brightness values of block 2 in the concealment macroblock, and block 0 in the lower neighbor. Since the mean brightness value of block 10 in the concealment macroblock, will be an accurate replica of the mean brightness value of block 0 in the lower neighbor, setting mean brightness for block 8 as defined here, will enable a smooth blending in the vertical direction. This may eliminate the need for strong deblocking filtering.

At block 2812, one integer multiplication per brightness corrected 4×4 block is needed by this step.

At block 2814, one integer multiplication per brightness corrected 4×4 block is required by this step. Inverting a residual signal consisting of only a nonzero quantized DC coefficient is simply possible by uniformly adding a constant value to the prediction signal. Hence the reconstruction implied by this step is of very low computational complexity.

Mean Color Correction in the Chroma Channels

The algorithm achieving mean color (i.e. chroma channel), correction in the lower half of spatial concealment macroblocks, is very similar in its principals to the algorithm presented above for brightness correction.

With respect to FIG. 22, the 4×4 blocks with indices 2 and 3 in the chroma channel of the concealment macroblock, respectively receive mean value correction information from the 4×4 blocks with indices 0 and 1 in the same chroma channel of the lower neighboring macroblock. This correction happens in both chroma channels Cb and Cr for all concealment macroblocks.

High-Efficiency Partial Intra Decoding in H.264 Bitstreams

The reconstructed signal within a predictive (intra or inter) coded 4×4 (luma or chroma) block can be expressed as;
r=p+\tilde{Δ}
   where r, p and \tilde{Δ}, respectively denote the reconstructed signal (an approximation to the original uncompressed signal s), the prediction signal, and the compressed residual signal (an approximation to the original uncompressed residual signal Δ=s−p), all of which are integer valued 4×4 matrices.

The mean value (which could be any statistical measure) of the reconstructed signal within this 4×4 block can be expressed as;

$$\begin{matrix}\overline{r} = \frac{1}{16} {\sum }_{i , j} {r}_{i , j} \\ = \frac{1}{16} {\sum }_{i , j} ( {p}_{i , j} + {\tilde{Δ}}_{i , j} ) \\ = \frac{1}{16} {\sum }_{i , j} {p}_{i , j} + \frac{1}{16} {\sum }_{i , j} {\tilde{Δ}}_{i , j} \\ = \overline{p} + \overline{\tilde{Δ}} .\end{matrix}$$

With respect to the above formula, extracting mean brightness or color information from lower neighboring macroblock's 4×4 blocks requires the availability of \overline{p} and \overline{\tilde{Δ}}.

\overline{\tilde{Δ}} is only and simply related to the quantized DC coefficient of the compressed residual signal which is either immediately available from the bitstream (in case of intra_{—}4×4 coded luma blocks) or after some light processing for intra_{—}16×16 coded luma blocks and intra coded chroma blocks. The latter two cases' processing involves a (partially executed) 4×4 or 2×2 inverse Hadamard transform (requiring only additions/subtractions) followed by 4 or 2 rescaling operations (requiring 1 integer multiplication per rescaling).

It is adequate to know \overline{p} only approximately, and as described previously, this can be achieved through the use of a single formula dependent on the intra prediction mode used and specified in terms of the neighboring pixel values used in this prediction mode. Although this seems to be a computationally simple process, it obviously requires the availability of the neighboring pixel values to be used in the intra prediction. This in return implies some decoding processing to occur. Nevertheless, the required decoding is only partial and can be implemented very efficiently as described below.

The following are observations on intra coded macroblocks located immediately below a slice boundary.

1. Intra_{—}4×4 Coded MB Located Immediately Below a Slice Boundary

Here, we are interested in the uppermost four 4×4 blocks i.e. those with block indices b ε{0, 1, 4, 5} in FIG. 27, of an intra_{—}4×4 coded macroblock located immediately below a slice boundary.

FIG. 30 shows one embodiment of an intra_{—}4×4 block immediately below a slice boundary. The line AA′ marks the mentioned slice boundary and the yellow colored 4×4 block is the current one under consideration, 9 neighboring pixels which could have been used for performing the intra_{—}4×4 prediction, are not available since they are located on the other side of the slice boundary and hence they belong to another slice.

FIG. 31 illustrates the naming of neighbor pixels and pixels within an intra_{—}4×4 block. The availability of neighboring pixels {I, J, K, L} only implies that the permissible intra_{—}4×4 prediction modes for the current 4×4 block are limited to {1 (horizontal), 2 (DC), 8 (horizontal-up)}. When neither {I, J, K, L} are available which would be the case if BB′ marks another slice boundary or the left border of the frame, the only permissible intra_{—}4×4 prediction mode is {2 (DC)}.

Hence, in the most general case, for an intra_{—}4×4 coded 4×4 block located immediately below a slice boundary, the information needed to be decoded and reconstructed is;
1. the intra_{—}4×4 prediction mode,
2. the residual information (quantized transform coefficients),
3. the values of the 4 neighboring pixels {I, J, K, L} located immediately to the left of the 4×4 block are required. This necessary and sufficient data set will enable the reconstruction of all pixel values {a, b, c, . . . , n, o, p} of the current 4×4 block and in particular of the pixel values {d, h, l, p} which in turn are required for the decoding of the 4×4 block immediately to the right.
   2. Intra_{—}16×16 Coded MB Located Immediately Below a Slice Boundary

Here again, the interest is in the uppermost four 4×4 blocks (i.e. those with block indices b ε{0, 1, 4, 5} in FIG. 27), of an intra_{—}16×16 coded MB located immediately below a slice boundary.

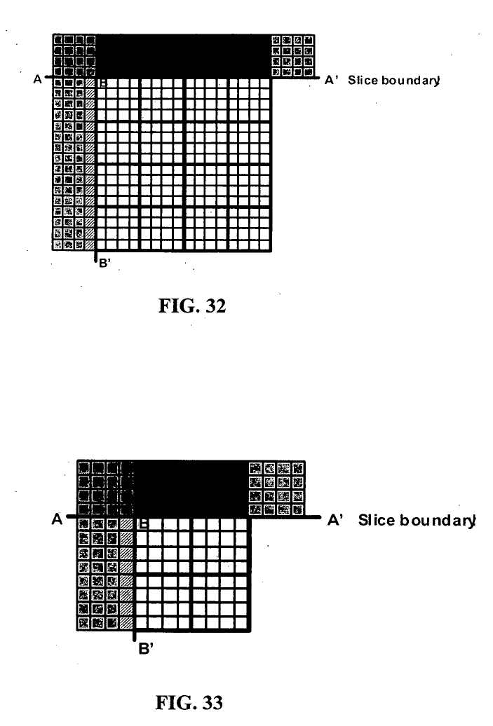

FIG. 32 shows one embodiment of an intra_{—}16×16 coded macroblock located below a slice boundary. The line AA′ marks the mentioned slice boundary and the yellow colored 4×4 blocks constitute the current (intra_{—}1 6×16 coded) MB under consideration, 17 neighboring pixels which could have been used for performing the intra_{—}16×16 prediction, are not available since they are located on the other side of the slice boundary and hence they belong to another slice. The potential availability of only 16 neighboring pixels—those located immediately to the left of line BB′, implies that the permissible intra_{—}16×16 prediction modes for the current macroblock are limited to {1 (horizontal), 2 (DC)}. When neither the 16 neighboring pixels located immediately to the left of line BB′ are available which would be the case if BB′ marks another slice boundary or the left border of the frame, the only permissible intra_{—}16×16 prediction mode is {2 (DC)}.

When the current macroblock is encoded using the Intra_{—}16×16_Horizontal prediction mode, then the availability of only the topmost four neighboring pixels located immediately to the left of line BB′ is adequate for decoding and reconstructing the topmost 4 4×4 blocks within the current macroblock. This is consistent with the above described ‘minimal dependency on neighboring pixels’ framework enabling the decoding of only the topmost 4 4×4 blocks in intra_{—}4×4 coded macroblocks.

On the other hand, when the current macroblock is encoded using the Intra_{—}16×16_DC prediction mode (and is not immediately to the right of a slice boundary nor on the left frame boundary), then the availability of all 16 neighboring pixels located immediately to the left of line BB′ is required for decoding and reconstructing the topmost 4 4×4 blocks within the current MB (as well as all others). This destroys the sufficiency of only the topmost 4 neighboring pixels and is not desirable for our purposes.

Based on these observations, the current efficient partial decoding framework proposes and will benefit from the limited use of the Intra_{—}16×16_DC prediction mode in the following manner:

Only for those intra_{—}16×16 coded macroblocks which are located immediately below a slice boundary and which are neither immediately to the right of a slice boundary nor at the left frame boundary, the use of Intra_{—}16×16_DC prediction mode should be avoided and for these macroblocks Intra_{—}16×16_Horizontal prediction mode should be uniformly employed.

3. Intra Coded Chroma Channel for a MB Located Immediately Below a Slice Boundary

The interest here is in the uppermost two 4×4 blocks (i.e. those with block indices in the set {0, 1} in FIG. 22), of either of the two luminance channels (Cb or Cr) of an intra coded macroblock located immediately below a slice boundary.

FIG. 33 shows one embodiment of a chroma channel immediately below a slice boundary. The line AA′ marks the mentioned slice boundary and the yellow colored 4×4 blocks constitute one of the current (intra coded) macroblocks chroma channels, 9 neighboring pixels which could have been used for performing the intra prediction in this chroma channel, are not available since they are located on the other side of the slice boundary and hence they belong to another slice. The potential availability of only 8 neighboring pixels—those located immediately to the left of line BB′, implies that the permissible chroma channel intra prediction modes for the current MB are limited to {0 (DC), 1 (horizontal)}. When neither the 8 neighboring pixels located immediately to the left of line BB′ are available which would be the case if BB′ marks another slice boundary or the left border of the frame, the only permissible chroma channel intra prediction mode is {0 (DC)}.

When the current (intra coded) macroblock's chroma channels are encoded using the Intra_Chroma_Horizontal prediction mode, the availability of only the topmost four neighboring pixels located immediately to the left of line BB′ is adequate for decoding and reconstructing the topmost 2 4×4 blocks within the current MB's corresponding chroma channels. This is consistent with the above described ‘minimal dependency on neighboring pixels’ framework enabling the decoding of only the topmost 4 4×4 blocks in intra coded macroblocks' luma channels.

Likewise, when the current (intra coded) macroblock's chroma channels are encoding using the Intra_Chroma_DC prediction mode, the availability of only the topmost four neighboring pixels located immediately to the left of line BB′ is adequate for decoding and reconstructing the topmost 2 4×4 blocks within the current macroblock's corresponding chroma channels. This is again consistent with the above described ‘minimal dependency on neighboring pixels’ framework

Efficient partial Coding of Residual Information in H.264

Here the problem of efficiently decoding only the fourth i.e. the last, column of the residual sign component of a 4×4 block contributing to the reconstruction of final pixel values for positions {d, h, l, p} in FIG. 31, will be addressed.

The 16 basis images associated with the transformation process for residual 4×4 blocks can be determined to be as follows where sij (for i,j ε{0,1,2,3}) is the basis image associated with ith horizontal and jth vertical frequency channel.

$$\begin{matrix}s00 = [ \begin{matrix}1 & 1 & 1 & 1 \\ 1 & 1 & 1 & 1 \\ 1 & 1 & 1 & 1 \\ 1 & 1 & 1 & 1\end{matrix} ] ; \\ s10 = [ \begin{matrix}1 & 0.5 & - 0.5 & - 1 \\ 1 & 0.5 & - 0.5 & - 1 \\ 1 & 0.5 & - 0.5 & - 1 \\ 1 & 0.5 & - 0.5 & - 1\end{matrix} ] ; \\ s20 = [ \begin{matrix}1 & - 1 & - 1 & 1 \\ 1 & - 1 & - 1 & 1 \\ 1 & - 1 & - 1 & 1 \\ 1 & - 1 & - 1 & 1\end{matrix} ] ; \\ s30 = [ \begin{matrix}0.5 & - 1 & 1 & - 0.5 \\ 0.5 & - 1 & 1 & - 0.5 \\ 0.5 & - 1 & 1 & - 0.5 \\ 0.5 & - 1 & 1 & - 0.5\end{matrix} ] ; \\ s01 = [ \begin{matrix}1 & 1 & 1 & 1 \\ 0.5 & 0.5 & 0.5 & 0.5 \\ - 0.5 & - 0.5 & - 0.5 & - 0.5 \\ - 1 & - 1 & - 1 & - 1\end{matrix} ] ; \\ s11 = [ \begin{matrix}1 & 0.5 & - 0.5 & - 1 \\ 0.5 & 0.25 & - 0.25 & - 0.5 \\ - 0.5 & - 0.25 & 0.25 & 0.5 \\ - 1 & - 0.5 & 0.5 & 1\end{matrix} ] ; \\ s21 = [ \begin{matrix}1 & - 1 & - 1 & 1 \\ 0.5 & - 0.5 & - 0.5 & 0.5 \\ - 0.5 & 0.5 & 0.5 & - 0.5 \\ - 1 & 1 & 1 & - 1\end{matrix} ] ; \\ s31 = [ \begin{matrix}0.5 & - 1 & 1 & - 0.5 \\ 0.25 & - 0.5 & 0.5 & - 0.25 \\ - 0.25 & 0.5 & - 0.5 & 0.25 \\ - 0.5 & 1 & - 1 & 0.5\end{matrix} ] ; \\ s02 = [ \begin{matrix}1 & 1 & 1 & 1 \\ - 1 & - 1 & - 1 & - 1 \\ - 1 & - 1 & - 1 & - 1 \\ 1 & 1 & 1 & 1\end{matrix} ] ; \\ s12 = [ \begin{matrix}1 & 0.5 & - 0.5 & - 1 \\ - 1 & - 0.5 & 0.5 & 1 \\ - 1 & - 0.5 & 0.5 & 1 \\ 1 & 0.5 & - 0.5 & - 1\end{matrix} ] ; \\ s22 = [ \begin{matrix}1 & - 1 & - 1 & 1 \\ - 1 & 1 & 1 & - 1 \\ - 1 & 1 & 1 & - 1 \\ 1 & - 1 & - 1 & 1\end{matrix} ] ; \\ s32 = [ \begin{matrix}0.5 & - 1 & 1 & - 0.5 \\ - 0.5 & 1 & - 1 & 0.5 \\ - 0.5 & 1 & - 1 & 0.5 \\ 0.5 & - 1 & 1 & - 0.5\end{matrix} ] ; \\ s03 = [ \begin{matrix}0.5 & 0.5 & 0.5 & 0.5 \\ - 1 & - 1 & - 1 & - 1 \\ 1 & 1 & 1 & 1 \\ - 0.5 & - 0.5 & - 0.5 & - 0.5\end{matrix} ] ; \\ s13 = [ \begin{matrix}0.5 & 0.25 & - 0.25 & - 0.5 \\ - 1 & - 0.5 & 0.5 & 1 \\ 1 & 0.5 & - 0.5 & - 1 \\ - 0.5 & - 0.25 & 0.25 & 0.5\end{matrix} ] ; \\ s23 = [ \begin{matrix}0.5 & - 0.5 & - 0.5 & 0.5 \\ - 1 & 1 & 1 & - 1 \\ 1 & - 1 & - 1 & 1 \\ - 0.5 & 0.5 & 0.5 & - 0.5\end{matrix} ] ; \\ s33 = [ \begin{matrix}0.25 & - 0.5 & 0.5 & - 0.25 \\ - 0.5 & 1 & - 1 & 0.5 \\ 0.5 & - 1 & 1 & - 0.5 \\ - 0.25 & 0.5 & - 0.5 & 0.25\end{matrix} ] ;\end{matrix}$$

A careful look at these 16 basis images reveals that their last columns actually contain only four distinct vectors. This should be intuitively clear since the last column being a 4×1 matrix/vector lies in a four-dimensional vector space and hence requires exactly 4 basis vectors to be expressed.

When the quantized transform coefficients (i.e. levels, zij i,j ε{0,1,2,3}, are received in the bitstream and rescaled to generate the coefficients w′ij i,j ε{0,1,2,3}, to go into the inverse transform (i.e. to generate the weights to weigh the basis images in the synthesis process), the above observation implies that the reconstruction expression for the last column of the residual signal can be written as:
(w′00−w′10+w′20−w′30/2)*[1 1 1 1]T+ . . .
(w′01−w′11+w′21−w′31/2)*[1 0.5 −0.5 −1]T+ . . . (w′02−w′12+w′22−w′32/2)*[1 −1 −1 1]T+ . . . (w′03−w′13+w′23−w′33/2)*[0.5 −1 1 −0.5]T.

Note that once the four scalar quantities in the parentheses above are calculated, only right shifts and additions/subtractions are required.

One more observation regarding the rescaling process i.e. transforming zij i,j ε{0,1,2,3} to w′ij i,j ε{0,1,2,3}, will reveal another source of significant complexity savings. Note that the rescaling factors vij i,j ε{0,1,2,3} which are used to scale zij ij ε{0,1,2,3}, in addition to their dependence on (QP_{Y} % 6), also posses the following positional structure within a 4×4 matrix:

$$\begin{matrix}{v}_{00} & {v}_{10} & {v}_{20} & {v}_{30} \\ {v}_{01} & {v}_{11} & {v}_{21} & {v}_{31} \\ {v}_{02} & {v}_{12} & {v}_{22} & {v}_{32} \\ {v}_{03} & {v}_{13} & {v}_{23} & {v}_{33}\end{matrix}$$

where rescaling factors with the same color have the same value for a given QP_{Y}. This can be used to advantage to reduce the number of multiplications required to generate w′ij from zij as follows. Note that in the above given weighted basis vectors sum formula to reconstruct the residual signal's last column, the first weight weighing the basis vector [1 1 1 1]^{T} contains the sum of w′₀₀ and w′₂₀ rather than the individual values of these two weights. Therefore, instead of individually calculating these two values and summing them up which would have required to integer multiplications, we can add z₀₀ and z₂₀ first and then rescale them with v₀₀=v₂₀, to get the same sum value through only one integer multiplication. (For the sake of simplicity, another common multiplicative factor given by a power of two has not been explicitly mentioned in this discussion.)

Other than these straightforward reductions in the computational requirements for executing this partial decoding, also fast algorithms to calculate only the desired last column of the residual signal can be designed.

Another practical fact which will lead to low computational requirements for this partial decoding process is that most of the time out of a maximum of 16 quantized coefficients within a residual signal block, only a few, typically less than 5, are actually non-zero. The above in conjunction with this fact can be used to further almost halve the required number of multiplications.

Incorporating Directivity Information from the Lower Neighbor to Lower Half of Concealed Macroblocks

Here, a framework which enables incorporating information about directional structures (vertical and close-to-vertical ones) from the lower neighboring macroblock into the concealment macroblock in addition to brightness and color correction in the concealment macroblock will be described.

The first step is the synthesis of a zero residual (i.e. basic version SEC like), concealment macroblock in which the intra_{—}4×4 prediction modes of all of the lower 8 4×4 blocks, (i.e. those 4×4 blocks with block indices b ε{8, 9, . . . , 15} in FIG. 27), are uniformly set to 2 (DC). This will enable the use of both brightness/color and directivity information from the above neighboring macroblock for the upper half of the concealment macroblock, and put the lower half of the concealment macroblock into a state most amenable to incorporate similar information from the lower neighboring macroblock.

For any one of these 8 4×4 blocks in the lower half of the concealment macroblock, the reconstructed signal can be expressed as (before):
r=p+\tilde{Δ}

Note that, in the above due to intra_{—}4×4_DC prediction p is a very simple signal which maps to a single nonzero (DC) coefficient in the transform domain.

We, will further let \tilde{Δ}, (the refinement/enhancement to the concealment of the current 4×4 block in the form of a nonzero residual signal), be composed of 3 terms as follows:
r=p+\tilde{Δ}₁+\tilde{Δ}₂+\tilde{Δ}₃.

We will chose \tilde{Δ}₁=−p. This is very easy to achieve since it is straightforward to calculate p and its transform domain representation. This will clear out the entire 4×4 block with respect to any influence from the above neighbor, leaving a reconstruction for that 4×4 block given by
r=\tilde{Δ}₂+\tilde{Δ}₃.

As the quantized coefficients i.e. indices, of the lower neighboring macroblock's uppermost four 4×4 blocks (dashed 4×4 blocks in FIG. 22) become available, an efficient (simple and accurate) block classification logic will classify these four 4×4 blocks into two classes: 1. Contains a significant vertical or close-to-vertical directional structure; 2. Does not contain a directional structure, which is either vertical or close-to-vertical. It is easy to understand that the interest is in detecting only vertical or close-to-vertical directional structures existing in the lower neighbor since only these are the ones that are likely to propagate into the lower half of the concealment macroblock.

The complete reconstructed signal having two components i.e. a prediction signal and a residual signal, in these four uppermost 4×4 blocks of the lower neighboring macroblock, does not really hurt this classification process through requiring a decoding be done. As explained below decoding is not necessary and the above mentioned classification can be accurately achieved on the basis of the residual signal i.e. its transform domain representation, only. The reason for this is as follows. As discussed above an intra_{—}4×4 coded 4×4 block located immediately below a slice boundary can be predicted only using one of the modes {1 (horizontal), 2 (DC), 8 (horizontal-up)}. None of these modes are good matches to vertical or close-to-vertical directional structures with respect to providing a good prediction of them. Hence in case of significant vertical and close-to-vertical structures, the residual signal power in these uppermost four 4×4 blocks will be substantial in particular in the horizontal frequency channels. This will enable simple and accurate classification as described above. An exactly similar argument holds for uppermost 4×4 blocks in intra_{—}16×16 coded lower neighbors, and in the chroma channels of intra coded lower neighbors.

If an uppermost (luma or chroma channel) 4×4 block in the intra coded lower neighbor is classified to be in Class 2, then it only contributes a brightness/color correction as described above.

If an uppermost (luma or chroma channel) 4×4 block in the intra coded lower neighbor is classified to be in Class 1, then it contributes its entire information in the pixel domain i.e. both brightness/color and directivity, through the technique described next.

In one embodiment, the technique comprises letting
\tilde{Δ}₂+\tilde{Δ}₃=r_{LN,i}=p_{LN,i}+\tilde{Δ}_{LN,i}
in particular
\tilde{Δ}₂=p_{LN,i}
and
\tilde{Δ}₃=\tilde{Δ}_{LN,i}
   for a 4×4 block in the lower half of the concealment macroblock which is decided to be influenced by the vertical or close-to-vertical directional structure present in the lower neighbor i.e. in its 4×4 block classified as Class 1. The framework in which this influence propagation happens, is described below and is very similar to the directivity information propagation in the basic zero-residual concealment macroblock synthesis process. The following considers the consequences of the above choices for \tilde{Δ}₂ and \tilde{Δ}₃.

Assume that block i, i ε{0, 1, 4, 5}, in the lower neighboring macroblock is classified to be in Class 1, and its reconstructed signal, prediction signal component and residual signal component are respectively denoted by r_{LN,i}, p_{LN,i} and \tilde{Δ}_{LN,i}, ‘LN’ in the subscript stands for ‘Lower Neighbor’ and ‘i’ for the index of the block under consideration.

The above \tilde{Δ}₂ and \tilde{Δ}₃ clearly lead to;
r=\tilde{Δ}₂+\tilde{Δ}₃=r_{LN,i},
enabling the exact copying/reproduction of the lower neighboring Class 1 4×4 block's pixel domain contents into appropriately selected (based on existing directional properties) 4×4 blocks within the lower half of the concealment macroblock.

\tilde{Δ}₃=\tilde{Δ}_{LN,i}, is trivial and entails just copying the residual signal i.e. quantized coefficients, levels, of the Class 1 lower neighboring 4×4 block, into the residual signal of the concealment 4×4 block.

\tilde{Δ}₂=p_{LN,i}, is less trivial but it still can be achieved in a very simple manner. This choice for \tilde{Δ}₂ obviously enables taking into account the prediction signal component of the Class 1 lower neighboring 4×4 block. Recall that only three types of intra_{—}4×4 prediction modes are possible if the Class 1 lower neighboring 4×4 block is part of the luma channel of an intra_{—}4×4 coded MB. In this case;
if intra_{—}4×4_DC mode is used, then as described above p_{LN,i} has a very simple transform domain structure and \tilde{Δ}₂ can easily be calculated.
if intra_{—}4×4_horizontal mode is used, then p_{LN,i} has a somehow more complicated but still manageable transform domain structure and \tilde{Δ}₂ can be calculated.
if intra_{—}4×4_horizontal_up is used, then p_{LN,i}'s transform domain structure becomes further complicated rendering \tilde{Δ}₂ calculation a less attractive approach.

Very similar arguments hold for Class 1 lower neighboring 4×4 blocks originating from either intra_{—}16×16 coded macroblocks' luma channels or intra coded macroblocks' chroma channels, with the exception that in these cases intra prediction modalities corresponding to intra_{—}4×4_horizontal_up are not present and the situation for \tilde{Δ}₂ calculation is much more welcoming.

Based on these observations, the current framework for incorporating both brightness/color and directivity information from lower neighboring macroblocks, proposes and will benefit from the preferred/biased use of the Intra_{—}4×4_DC prediction mode in the following manner.

Only for the uppermost four 4×4 blocks of an intra_{—}4×4 coded macroblock which is located immediately below a slice boundary, and only when there is a significant vertical or close-to-vertical directional structure in one of these 4×4 blocks—in which case none of the three permissible intra_{—}4×4 prediction modes provide a good predictor—uniformly choose and employ intra_{—}4×4_DC mode.

The manner in which a Class 1 lower neighboring 4×4 block's complete data influences a select subset of 4×4 blocks in the lower half of a concealment MB is simply dependent on the detected directivity properties for that Class 1 block. A finer classification as to the slope of the (sign and magnitude) Class 1 4×4 can be used to identify propagation courses.

Accordingly, while one or more embodiments of a spatial error concealment system have been illustrated and described herein, it will be appreciated that various changes can be made to the embodiments without departing from their spirit or essential characteristics. Therefore, the disclosures and descriptions herein are intended to be illustrative, but not limiting, of the scope, which is set forth in the following claims.

What is claim ed is:

1. A method for spatial error concealment, the method comprising:
detecting a damaged macroblock;
obtaining coded macroblock parameters associated with one or more neighbor macroblocks;
generating concealment parameters based on the coded macroblock parameters; and
inserting the concealment parameters into a video decoding system.

2. The method of claim 1, further comprising determining a directivity characteristic associated with each of the one or more neighbor macroblocks.

3. The method of claim 2, further comprising determining unit vectors for the directivity characteristics.

4. The method of claim 3, further comprising assigning a weight to each of the unit vectors based on a prediction quality characteristic associated with each of the one or more neighbors to produce weighted vectors.

5. The method of claim 4, further comprising combining the weighted vectors to produce a concealment directivity indicator.

6. The method of claim 5, further comprising quantizing the concealment directivity indicator into a selected concealment mode indicator.

7. The method of claim 1, wherein said generating comprises setting concealment coefficients to zero.

8. Apparatus for spatial error concealment, the apparatus comprising:
logic configured to detect a damaged macroblock;
logic configured to obtain coded macroblock parameters associated with one or more neighbor macroblocks;
logic configured to generate concealment parameters based on the coded macroblock parameters; and
logic configured to insert the concealment parameters into a video decoding system.

9. The apparatus of claim 8, further comprising logic configured to determine a directivity characteristic associated with each of the one or more neighbor macroblocks.

10. The apparatus of claim 9, further comprising logic configured to determine unit vectors for the directivity characteristics.

11. The apparatus of claim 10, further comprising logic configured to assign a weight to each of the unit vectors based on a prediction quality characteristic associated with each of the one or more neighbors to produce weighted vectors.

12. The apparatus of claim 11, further comprising logic configured to combine the weighted vectors to produce a concealment directivity indicator.

13. The apparatus of claim 12, further comprising logic configured to quantize the concealment directivity indicator into a selected concealment mode indicator.

14. The apparatus of claim 8, further comprising logic configured to set concealment coefficients to zero.

15. Apparatus for spatial error concealment, the apparatus comprising:
means for detecting a damaged macroblock;
means for obtaining coded macroblock parameters associated with one or more neighbor macroblocks;
means for generating concealment parameters based on the coded macroblock parameters; and
means for inserting the concealment parameters into a video decoding system.

16. The apparatus of claim 15, further comprising means for determining a directivity characteristic associated with each of the one or more neighbor macroblocks.

17. The apparatus of claim 16, further comprising means for determining unit vectors for the directivity characteristics.

18. The apparatus of claim 17, further comprising means for assigning a weight to each of the unit vectors based on a prediction quality characteristic associated with each of the one or more neighbors to produce weighted vectors.

19. The apparatus of claim 18, further comprising means for combining the weighted vectors to produce a concealment directivity indicator.

20. The apparatus of claim 19, further comprising means for quantizing the concealment directivity indicator into a selected concealment mode indicator.

21. The apparatus of claim 15, further comprising means for setting concealment coefficients to zero.

22. A computer-readable media comprising instructions, which when executed by at least one processor, operate to provide spatial error concealment, the computer-readable media comprising:
instructions for detecting a damaged macroblock;
instructions for obtaining coded macroblock parameters associated with one or more neighbor macroblocks;
instructions for generating concealment parameters based on the coded macroblock parameters; and
instructions for inserting the concealment parameters into a video decoding system.

23. The computer-readable media of claim 15, further comprising instructions for determining a directivity characteristic associated with each of the one or more neighbor macroblocks.

24. The computer-readable media of claim 16, further comprising instructions for determining unit vectors for the directivity characteristics.

25. The computer-readable media of claim 17, further comprising instructions for assigning a weight to each of the unit vectors based on a prediction quality characteristic associated with each of the one or more neighbors to produce weighted vectors.

26. The computer-readable media of claim 18, further comprising instructions for combining the weighted vectors to produce a concealment directivity indicator.

27. The computer-readable media of claim 19, further comprising instructions for quantizing the concealment directivity indicator into a selected concealment mode indicator.

28. The computer-readable media of claim 15, further comprising instructions for setting concealment coefficients to zero.

29. At least one processor configured to perform a method for spatial error concealment, the method comprising:
detecting a damaged macroblock;
obtaining coded macroblock parameters associated with one or more neighbor macroblocks;
generating concealment parameters based on the coded macroblock parameters; and
inserting the concealment parameters into a video decoding system.

30. The method of claim 29, further comprising determining a directivity characteristic associated with each of the one or more neighbor macroblocks.

31. The method of claim 30, further comprising determining unit vectors for the directivity characteristics.

32. The method of claim 31, further comprising assigning a weight to each of the unit vectors based on a prediction quality characteristic associated with each of the one or more neighbors to produce weighted vectors.

33. The method of claim 32, further comprising combining the weighted vectors to produce a concealment directivity indicator.

34. The method of claim 33, further comprising quantizing the concealment directivity indicator into a selected concealment mode indicator.

35. The method of claim 29, wherein said generating comprises setting concealment coefficients to zero.

36. A method for spatial error concealment, the method comprising:
detecting a damaged macroblock;
obtaining coded macroblock parameters associated with one or more non-causal neighbor macroblocks;
generating concealment parameters based on the coded macroblock parameters; and
inserting the concealment parameters into a video decoding system.
